(19) United States
(12) Patent Application Publication
(10) Pub. No.: US 2006/0055175 A1
(43) Pub. Date: Mar. 16, 2006

(54) Hybrid thermodynamic cycle and hybrid energy system

(76) Inventor: Zinovy D. Grinblat, Medford, MA (US)

Correspondence Address: ZINOVY D. GRINBLAT, 8 NINTH STR #616, MEDFORD, MA, 02155, US

(21) Appl. No.: 10/939,703

(22) Filed: Sep. 14, 2004

(51) Int. Cl. F03B 13/00; H02P 9/04

(52) U.S. Cl. 290/54

(57) ABSTRACT

The presented invention provides of hybrid thermodynamic cycle and a hybrid energy system as a method of reduction of fossil fuel consumption, maximum utilization of energy from renewable energy sources, increasing hybrid energy systems' efficiency and operating time, and transforming these systems from supplemental to primary energy producers. The hybrid thermodynamic cycle is a method of integration of incompatible types of energy, such as solar radiation, fossil fuel, kinetic energy of wind, of the ocean tide and wave, and of the river water. The integration process involves collection, conversion, operation, storage, and transmitting of incompatible energies using kinetic energy collectors, compressors, solar and air heat energy exchangers, air and thermal storages, piston and gas turbine heat engines, electrical generators, and air and electrical transmission lines. Surrounding air is used as an intermediate working substance in the hybrid thermodynamic cycle. A hybrid thermodynamic cycle is a two-phase method of converting renewable energy into mechanical/electrical energy. A first phase of converting renewable energy into mechanical/electrical energy includes: conversion of low oscillating renewable kinetic energy into heat energy; preparing and storing of a standardized (cooled) compressed air; collecting and storing of renewable solar radiation and kinetic energy in the form of heat energy. A second phase of converting renewable energy into mechanical/electrical energy includes: returning of stored a standardized compressed air and heat energy to a conversion system; conversion of heat energy into mechanical/electrical energy in a phase of high spinning heat engine-generator's shaft.

### BACKGROUND OF THE INVENTION

1. Field of the Invention

This invention relates to the hybrid thermodynamic cycle method and hybrid energy system based thereon.

2. Description of the Related Art

FIG. 1 illustrates current thermodynamic cycles. These thermodynamic cycles provide conversion of energy of kinetic wind, tide-wave of ocean, and water of rivers, solar radiation and burning of fuel heat energy into mechanical and electrical energy. On Earth, kinetic energies, such as water of river 2, wind 3, and tide-wave of ocean 4, is all products of solar radiation energy 1. These types of kinetic energy are collected by mechanical collectors 7-9 and then are directly converted into electrical energy by the generators 11-13. The solar radiation collector 5 collects solar radiation energy in the phase of steam energy, then the steam turbine 10 and generator 14 convert steam energy into mechanical-electrical energy. Photovoltaic cells 6 directly convert solar radiation energy into electrical energy. Another current thermodynamic cycle permits the heat engine 17 to convert the realized heat of combustion reaction of fossil fuel 15 and air 16 into mechanical energy, and then the generator 18 converts its mechanical energy into electrical energy. Still another current thermodynamic cycle permits the realized heat of fossil fuel 19 to convert water 21 into the steam energy 20. Then, the steam turbine 22 converts its energy into mechanical energy in the phase of rotating shaft of the steam turbine. Then the generator 23 converts mechanical energy into electrical energy.

The features and disadvantages of the current thermodynamic cycles are illustrates below on a current gas turbine, internal combustion, steam, solar and fuel cell engines, and wind, water of river, tide and wave of the ocean kinetic energy collectors.

As fuel is burnt in the Otto heat engine, 20% of the heat energy of fuel is used as useful energy. The rest is lost in the following way: 35% of the heat energy is lost through exhaust gas, 35% of the heat energy is lost through the wall of combustion chamber, and 10% of the heat energy is lost on friction and pumping. The Otto heat engine that is used in conventional vehicles loses additional 10% of heat energy on a power train and about 17% on idling at stoplight and in traffic. Transportation consumes third and buildings consume another third of the energy in USA. Efficiency of the conventional vehicle is about 20%, of the hybrid electrical drive system is about 29%, and of the electrical vehicle is about 27% (efficiency of the electrical power plant is about 33%, transmission line trims about 10%, and charging battery additionally trims about 10%). Net efficiency of the cogeneration plants, which produce both electricity and heat, is about 80-90%, and of the fuel cell engine is about 40-50%. Transportation accounts for about half of all air pollution emissions worldwide, and more than 80 percent of air pollution emissions in cities. A cold catalytic converter of heat engines and a short trip of running of vehicles account for the most of air polluting emissions in cities. In the future growing fuel consumption by transportation and power plants will create a climatic and environmental instability. Most transportation and power plants use combustion heat engines, such as Otto, Diesel, and Brayton. Otto heat engine is an inexpensive internal combustion, low-compression engine with a low thermal efficiency. Diesel heat engine is an expensive internal combustion engine, but with thermal efficiency of about 30-35%. The Brayton heat engine is the internal combustion engine generally used for planes and electric power plants. The Brayton heat engine with regenerator has high power density and thermal efficiency of about 33%. The Otto, Diesel and Brayton heat engines lose thermal efficiency because they do not completely expand high-pressure gases and use surrounding air and water for disposal of excess wall and exhaust gases temperatures.

Disadvantage of the current gas turbine is the necessity to prepare its own pressurized gas by a compressor connected to the shaft of the gas turbine. 70% of the power generated inside Brayton heat engines is spent to drive a compressor. The efficiency of the gas turbine power plant is increased by addition of a separate compressor which prepares and stores a high-pressure compressed air during off-peak hours and then returns the stored compressed air back into the system during peak hours. However, this method does not eliminate the need for burning of fossil fuels in order to heat the compressed air and to rotate the turbine.

Disadvantage of the current steam engine is the necessity to use water of a river or a lake for disposal of excess heat. An increase of water temperature by several degrees may influence the environment.

One disadvantage of the hydraulic power plants is that the construction of dams is a significant contributor to the cost of the electricity. Another disadvantage is that water reservoirs need a lot of land.

Most of the current wind power plants produce constant power when above a certain wind speed. The basic parts of a wind electrical power plant are a wind turbine, a generator, a tower, a gearbox, electronic and mechanical controllers, batteries, and disk brakes. The electronic controller keeps rated power of the output of the generator at a typical wind speed between 10-20 m/sec. Wind turbines cannot operate at wind speed above 20 m/sec because of generator overheating and cannot operate at wind speed below 4.5 m/s because the electronic controller has to keep frequency constant, since alternating current must match with the electrical grids. Constant rotational speed of the generator is usually maintained by the stall, pitch, yaw control systems, and disk brakes. The low rotational speed of blades and high rotational speed of the generator must be coordinated using costly and heavy gears. Major disadvantage of keeping frequency of the electrical system constant is less efficient when wind turbines extract power from the wind. The theoretical power efficiency of the wind turbine, known as Betz criterion, is about 59.3%. In practice, however, its power efficiency is about 25-35% and total efficiency of the wind power plant is about 15-20%. Disadvantage of using variable rotor speed is increasing complexity of the power electronics, cost and weight of the generator. Combining the solar, wind, and fossil fuel energies usually increases the operating time of a small wind power plant. Its hybrid power plant includes a wind turbine-generator, solar photovoltaic panels, an electrical storage media (battery), and Diesel engine-generator. The battery increases the operating time of the hybrid power plant to about 60% by providing electrical energy to the customers during periods of low production of electrical energy by the wind and solar energy sources. The Diesel engine-generator increases the operating time of the hybrid power plant up to 100%. Disadvantage of using batteries in the hybrid power plant is that batteries need maintenance, and every 3-4 years batteries must be replaced. Major disadvantage of using photovoltaic panels and batteries in the hybrid power plants is high initial cost. It means that it is inefficient for large hybrid power plants to increase their operating time by using the photovoltaic panels and batteries. Disadvantage of using the current Diesel heat engine is that exhaust products from burning fossil fuel are not friendly to the environment.

Major disadvantage of using the current method of producing electricity is the realizing tidal kinetic energy is that turbine-generator has to be shut down at times of flooding tide in the basin, and times of ebbing tide, to make a suitable difference in the level of basin and of seawater to produce electricity. Moreover, the ebbing time and peak hours of consumption of electrical energy by the customers may not match.

Moreover, using the current method of converting tidal kinetic energy into electricity is that there are only a couple of the coastlines of the ocean in the world where tidal power plants can produce electricity profitably (tidal range should be over 5 meters). In the U.S., for example, a maximum tidal range over 5 meters occurs in Maine and Alaska.

Disadvantages of the wave electrical power plant are their mechanical and electrical complexity, great inertia, and the necessity of being linked to the electrical lines by expensive undersea cables.

Fuel cell technology uses hydrogen to produce electricity. The product of fuel cells electrolysis of the hydrogen and oxygen is the electricity, water, and heat. Most of the hydrogen now produced in the United States comes from fossil fuel, such as natural gas, or from water. Extracting hydrogen from natural gas uses steam-reforming process. Stem-reforming process uses thermal energy to separate fuel into hydrogen and carbon monoxide (first step) and to carbon dioxide and hydrogen (second step). Steam-reforming process involves catalytic surfaces. Steam reforming process occurs at temperatures higher than 473K. Extracting hydrogen from water occurs at temperature higher than 1173K. The hydrogen needs to be cooled, needs a distributed infrastructure, or needs special devices to make hydrogen on electrical vehicles. Refrigerating hydrogen to 20K takes roughly 25-30 percent of heat energy content in the fuel. Hydrogen burning is about 50% more efficient than that of a gasoline. Burning hydrogen creates less air pollution, higher detonation temperature, burns hotter. It takes less energy to ignite hydrogen than gasoline. Burning hydrogen creates less air pollution emission than a gasoline combustion engine, but air pollutant such as nitrous oxides-NOX is present. Disadvantages of the fuel cell technology are very high capital costs, large size and weight, long start-up times, and necessary spend fossil fuel energy for making and compressing pure hydrogen. Furthermore, the cost, size, and weight of the fuel cell engine are now uncompetitive with current internal combustion engines.

Today most of the solar radiation is converted into heat energy phase and then heat energy is used for warming homes or pools. The pay back time is about 1-2 years. Another way of utilizing the solar radiation is to convert solar radiation energy into electricity by heating working substances and converting heat energy into mechanical energy by a heat engine, such as a Sterling engine. Then mechanical energy is converted into electrical energy by a generator. A solar electrical system combines a solar collector, a solar heat energy exchanger, and a heat engine-generator. The solar collector uses lens or curved mirrors to concentrate solar radiation to about 100-2000 times and then the tracking system focuses its solar radiation to a solar heat energy exchanger. Still another way of utilizing solar radiation is conversion of solar radiation directly into electricity by the photovoltaic cells. Disadvantage of using photovoltaic cells is that actual pay back time averages 20-25 years. Disadvantage of using solar radiation energy alone is that on cloudy days a solar radiation converter becomes useless. A small hybrid solar power plant usually operates with combined solar radiation and fossil fuel heat energy, and stores electrical energy in batteries. Disadvantage of using the current internal combustion heat engines is that its heat engines have low thermal efficiency and produce air pollution emission. Disadvantage of using batteries and photovoltaic panels is increased initial cost of the hybrid solar power plant. Moreover, batteries need maintenance, and every 3-4 years they must be replaced. This makes it impossible for a large hybrid solar power plant to increase the operating time profitably by using photovoltaic panels and batteries.

On today's roads, there are air, electric, fuel cell, and solar vehicles. The latter reduce air pollution emission the most. The air engine uses the compressed air as its “fuel”. Disadvantage of using the air vehicles is that special power plants are needed for compressing air and, moreover, most of the compressing systems are powered by the electrical energy. Yet another disadvantage of the air vehicles is a limited range of miles traveled. Another vehicle type that reduces air pollution emission is the electric vehicle (EV). The EV uses stored electrical energies in a battery, an ultracapacitor, and a flywheel. Disadvantages of EV's include a limited range of miles traveled between charges; the need of a power plant to charge the batteries, and the need of a second vehicle for driving on the highways. Another type of electric vehicle is a hybrid electric vehicle (HEV). The basic of the HEV combines a heat engine, cooling water and exhaust gas systems, a trunk, a gasoline or a gas tank, a battery, a generator, an electric motor, electromechanical power converter for delivering drive force to drive wheels, and a computer. The electric motor and the heat engine provide torque to drive the vehicle. The heat engine is operated in the highly efficient state and the electric motor produces peak torque at low RPM's. In the city-driving mode, the electric motor alone provides torque to drive the vehicle. In the highway-steady-driving mode, the heat engine alone provides torque to drive the vehicle. In the accelerating mode, both the heat engine and the electric motor provide torque to drive the vehicle. During the braking mode, the generator recharges the battery thus reclaiming energy for further use. Disadvantage of a HEV is that a lot of electrical energy from the battery is wasted in the city-driving mode. Its electrical energy is wasted on transporting the weight of the heat engine, the cooling water and the exhaust gas systems, the gasoline or the gas tanks and the own weight of the battery. Another disadvantage of the HIV is that it still accounts for air pollution emissions.

Most current patents concentrate on reducing local disadvantages of the heat engines, such as high fuel consumption, or utilization of wasted heat energy of exhaust products, or improving performance, or reducing air pollution emission. The present invention considers many disadvantages of current thermodynamic cycles and heat engines based thereon; attempts to reduce those disadvantages, increase thermal efficiency of heat engines, and improve environmental impact as well as to reduce consumption of fossil fuel and increase consumption of renewable energy sources, such as solar, wind, water of river, tide and wave of the oceans.

### SUMMARY OF THE INVENTION

One object of the present invention is to provide a hybrid thermodynamic cycle and a hybrid energy system as a method of integration of incompatible types of energy, such as solar radiation, fossil fuel, kinetic energy of wind, of the ocean tide and wave, and of the river water through an intermediate working substance—a non-polluting surrounding air. The integration process involves collection, conversion, operation, storage, and transmission of incompatible energies using kinetic energy collectors, compressors, solar and air heat energy exchangers, air and thermal storages, piston and gas turbine heat engines, electrical generators, and air and electrical transmission lines. The hybrid thermodynamic cycle has two phases of operation. In the first phase of operation, a low oscillating renewable kinetic energy is converted into heat energy in the phase of hot compressed air and additional air/oxygen is compressed and stored for future use. In the second phase of operation, heat energy is converted into mechanical and electrical energy.

Another object of the present invention is to provide a method of increasing efficiency and operating time of hybrid energy systems by collecting and storing solar radiation energy in the phase of heat energy, and renewable kinetic energy in the phase of compressed air/oxygen.

Still another object of the present invention is to provide a method of maximally extracting power from renewable energy sources by combined current (direct) and present (indirect) methods of utilizing renewable energy. A direct method of conversion of kinetic energies into electrical energies is comprised of coupling wind-wave-tide-water turbines through gearboxes to a coil armature and magnetic field, and rotating shafts of these turbines in a clockwise and in counterclockwise directions. Indirect method of conversion of kinetic energies into electrical energies is comprised of coupling wind-wave-tide-water turbines to a coil armature and magnetic field through compressors and gas turbines and rotating shafts of these gas turbines in a clockwise and in counterclockwise directions.

Still another object of the present invention is to provide a method of maximally extracting power from renewable energy sources by observe the following condition: the instantaneous energy produced should be completely consumed.

Still another object of the present invention is to provide a method of maximally extracting power from renewable energy sources by eliminating any limitations to the energy conversion system, with the exception of the strength of mechanical devices.

Still another object of the present invention is to provide a method of increasing efficiency of every component of the energy conversion system, such as installing farm of wind turbines on different heights of a tower, utilizing solar and renewable kinetic energies simultaneously, utilizing the exhaust gasses of the internal combustion engine, eliminating a compression-stroke and reducing an input-stroke in the current four-stroke thermodynamic cycle. In the present method, efficiency is also increased by eliminating/reducing air-polluting emissions by extracting carbon dioxide with pollutants from the exhaust products, collecting these gasses in the container and then disposing of stored carbon dioxide and pollutants by disposal stations or by heating the stored carbon dioxide with pollutants by solar radiation to the temperature of best performance of the catalytic converters for further disposal into the surrounding air.

The present method and system based thereon avoids disadvantages of known current energy systems such as electrical power plants, conventional, electric, hybrid electrical, air, and fuel cell vehicles. Disadvantages of the current conventional heat engines and electrical power plants are low thermal efficiency of energy conversion systems and air pollution. Disadvantages of electrical and air vehicles are low mileage of driving vehicles between charging air containers and batteries, low speed of running, and a need for a second car to drive on highways. Disadvantages of the hybrid electrical and fuel cell engines are high cost and their effect on air pollution. Benefits of using the present hybrid thermodynamic cycle method and hybrid energy system are: reducing consumption from fossil fuel, increasing consumption from renewable energy sources, and reducing/eliminating negative impact on environment. Benefits of using the present hybrid thermodynamic cycle method in the present hybrid drive system are: the heat engine can be operated under maximum power; the heat engine can significantly increase thermal and fuel efficiency; increased performance; environmental advantages over electric, hybrid electric, conventional, air, and fuel cells engines. The features and preferences of the present method and system based thereon will be apparent from the following description and from the accompanying drawings. The present invention does not include a drawing of some well known details, such as standard parts of valves, switches, clutches, pumps, gears, or similar in functionality elements.

### BRIEF DESCRIPTION OF THE DRAWINGS

FIG. 1 illustrates the current thermodynamic cycles.

FIG. 2a, 2b illustrates a cycle of a four-stroke four cylinder Otto heat engine.

FIG. 2c illustrates thermodynamic cycle of the Otto engine as a function of temperature.

FIG. 2d illustrates process of integrating two thermodynamic cycles.

FIG. 3a schematically illustrates the thermodynamic cycle of conversion of renewable low oscillating kinetic energies into mechanical energy in the phase of the gas turbines'high speed rotating shafts.

FIG. 3b schematically illustrates the thermodynamic cycle of conversion of low oscillating renewable kinetic energies into mechanical energy in the phase of high speed linear motion of a piston of a free piston engine.

FIG. 4 illustrates the process of integrating kinetic, solar and fossil fuel energies.

FIG. 5 illustrates the process of integrating renewable kinetic energy and fuel heat energy.

FIG. 6 schematically illustrates the integrated solar and combustion reaction thermodynamic cycles.

FIG. 7 schematically illustrates the operation of the hybrid power plant.

FIG. 8 schematically illustrates the basic operation of zero-polluting hybrid solar-wind power plants.

FIG. 9 illustrates a process of converting teetering motion of blades into electricity.

FIG. 10 illustrates the basics of extracting maximum power from the wind.

FIGS. 11, 12 illustrate the present method of weight and cost reduction of wind turbines.

FIG. 13 illustrates a static compressor.

FIG. 14 illustrates some kinematics of multi-turbine wind farms.

FIG. 15 illustrates the operation of the wind power plant.

FIG. 16 illustrates a process of utilizing electrical energy.

FIG. 17 illustrates an offshore wind-wave-tide hybrid power plant.

FIG. 18 illustrates the operation of the wave conversion system.

FIG. 19 illustrates the operation of the wave-solar power plant.

FIG. 20 illustrates the operation of the onshore wave turbine.

FIG. 21 illustrates the operation of the onshore hybrid wave-solar power plant.

FIG. 22 schematically illustrates the basic operation of the neighborhood hybrid power plant.

FIG. 23 schematically illustrates the basic operation of the thermal module.

FIG. 24 schematically illustrates the basic operation of the compressor.

FIG. 25 schematically illustrates the basic operation of the compressor as a heat engine.

FIG. 26 schematically illustrates polytrophic compression process.

FIG. 27 schematically illustrates adiabatic compression process.

FIG. 28 schematically illustrates application of the hybrid heat engine.

FIG. 29 schematically illustrates the present method of utilizing electrical energy.

FIG. 30 illustrates the process of utilizing extra electrical energy.

FIG. 31 illustrates thermodynamic three-stroke cycle of an internal combustion engine.

FIG. 32-33 illustrates the sequence of operation of the three-stroke cycle of the 2 cylinders internal combustion engine.

FIG. 34 schematically illustrates the operation of hybrid drive system.

FIG. 35 schematically illustrates the present method of reduction/eliminating of air pollution emission.

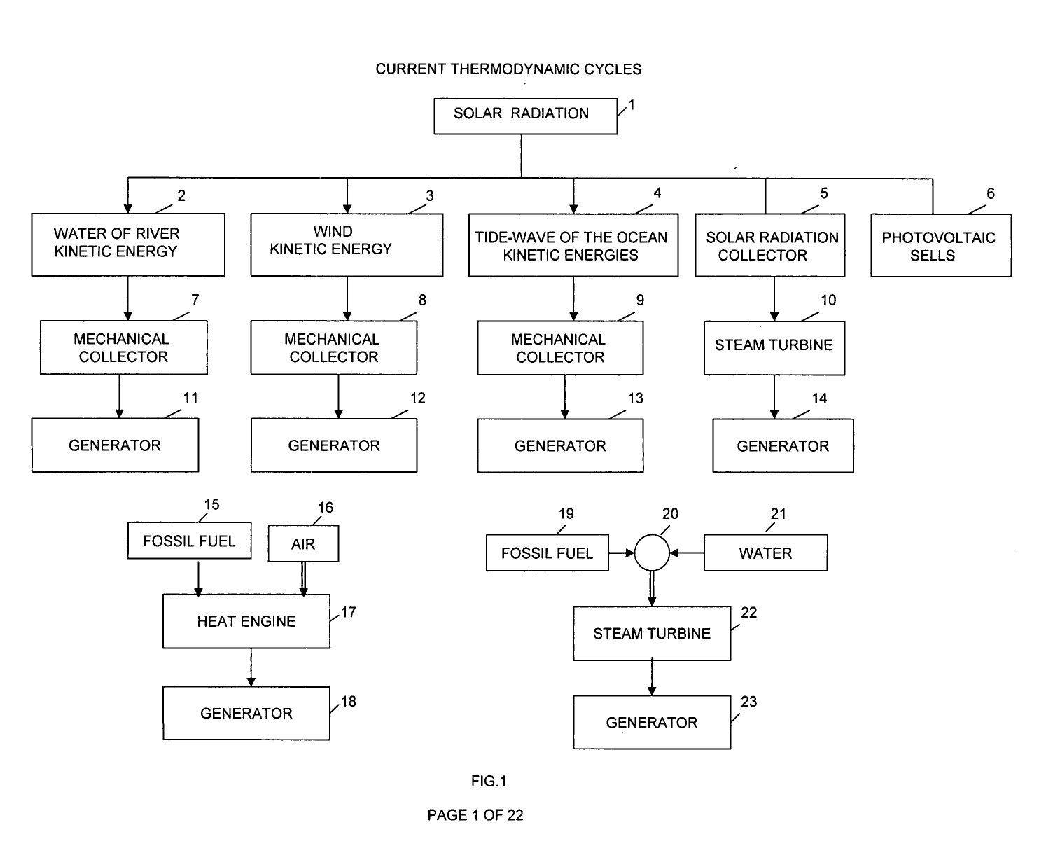

### DESCRIPTION OF THE PREFERRED METHOD AND SYSTEM

Today most of the current heat engines, such as the Otto, Diesel, and Brayton heat engines, are used for transportation and as electrical energy producers. Its heat engines convert heat energy content in the fossil fuel into mechanical energy. Combustion of 1 kg of fossil fuel produces roughly 40-50 MJ of heat energy. The thermal efficiency of the above thermodynamic cycles is low.

The present hybrid thermodynamic cycle method increases the thermal efficiency of the heat engines and reduces consumption of fossil fuel by integrating combustion reaction and solar thermodynamic cycles. In the present invention the solar thermodynamic cycle means non-polluting conversion of wind-water-tide-wave kinetic and solar radiation energies into mechanical energies. For better understanding the advantages of the present hybrid thermodynamic cycle method let me analyze the current four-stroke (Otto) thermodynamic cycle. The classical Otto thermodynamic cycle, which is used for more than a hundred years, includes: 1. The intake-stroke (the mixture of air and fuel passes into the cylinder). 2. The compression-stroke (the mixture of air and fuel is compressed). 3. The power-stroke (the compressed mixture ignites and does work by the realized heat of a combustion reaction). 4. The exhaust-stroke (the unavoidable heat energy in the phase of hot exhaust gasses is pushed out). The theoretical thermal efficiency of the Otto thermodynamic cycle is about 56%. A lot of factors, such as loses heat to cylinder wall, incomplete combustion, turbulence, and friction reduces thermal efficiency from theoretical obtained 56% to 20%. Following is the analysis of the causes of heat energy losses in the Otto heat engine.

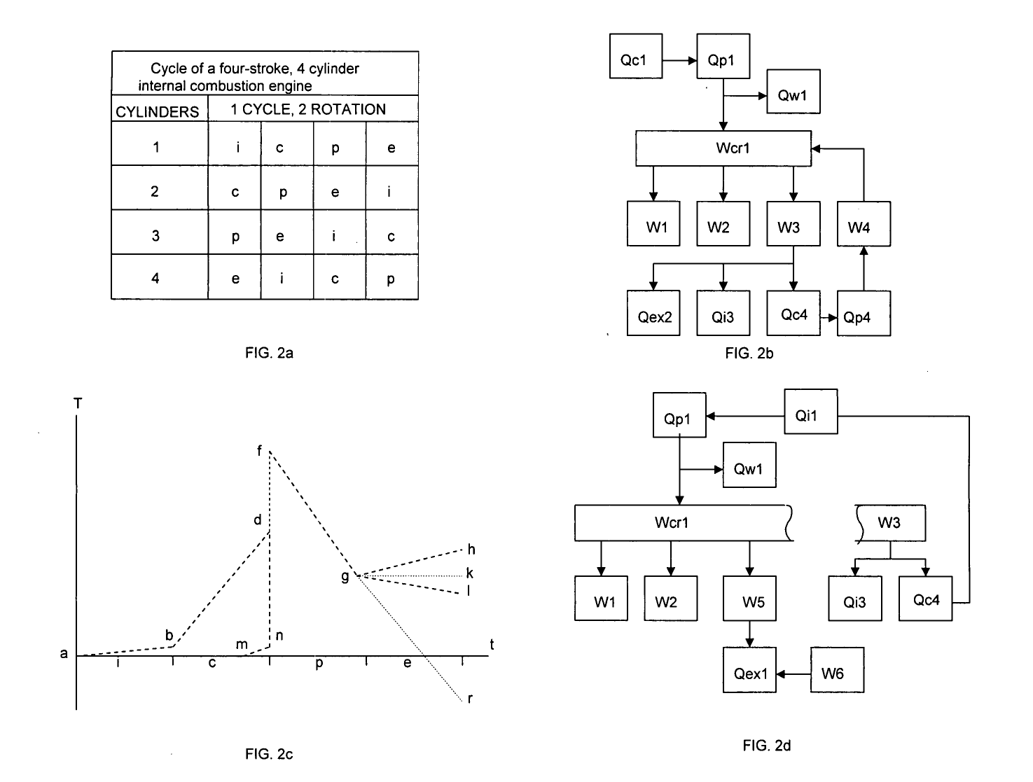

FIG. 2a illustrates a cycle of a four-stroke four cylinder Otto heat engine. Where:
i—is an intake-stroke (piston moves down);
c—a compression stroke (piston moves up);
p—a power stroke (piston moves down);
e—an exhaust stroke (piston moves up).
   Assume sequence starts from the power-stroke in cylinder 1. Sequence of operations of the four-stroke cycle Otto heat engine is: during the power-stroke the compressed mixture in cylinder 1 is ignited and the realized heat of combustion reaction is converted into mechanical energy in phase of pushing down the piston of the cylinder 1. The moving piston rotates the crankshaft of the Otto heat engine through the connecting rods. As crankshaft rotates, its mechanical energy is used for multiple purposes:

1. As useful energy to rotate wheels of the vehicle or a shaft of an electrical generator.

2. As maintenance energy to be used during the intake-stroke in the cylinder 3. During the intake-stroke, this maintenance energy is used to move the piston of the cylinder 3 down, thus making a partial vacuum and allowing the mixture of gasoline and air to flow through the open intake valve. The maintenance energy is also used to cover energy lost on pumping oil and water as well as on friction and through the wall. The intake-stroke takes ¼ of the Otto thermodynamic cycle. The above heat energy loses of the intake-stroke lower thermal efficiency of the Otto heat engine.

3. As maintenance energy to be used during the compression-stroke in the cylinder 4. During the compression-stroke, this maintenance energy is used to move the piston of the cylinder 4 up, thus compressing the mixture of gasoline and air. The maintaining energy compresses the mixture of fuel and air adiabatically. The maintenance energy is also used to cover energy lost on extra compression of mixture needed to keep the power of crankshaft constant, on pumping oil and water as well as on friction and through the wall. The compression-stroke takes ¼ of the Otto thermodynamic cycle. The above heat energy loses of the compression-stroke lower thermal efficiency of the Otto heat engine.

4. As maintenance energy to be used during the exhaust-stroke in the cylinder 2. During the exhaust-stroke, this maintenance energy is used to move the piston of the cylinder 2 up, thus pushing out unavoidable exhaust gasses. The maintenance energy is also used to cover energy lost on pumping oil and water as well as on friction and through the wall. The exhaust heat losses depend on the temperature of the exhaust gasses. The temperature of the exhaust gasses varies and depends on the load, the speed of rotation of the crankshaft of the Otto heat engine, and on the energy needed to keep the power of the crankshaft constant. The exhaust-stroke takes ¼ of the Otto thermodynamic cycle. The above heat energy loses of the exhaust-stroke lower thermal efficiency of the Otto heat engine.

The exhaust gasses temperature also influences the operation of a catalytic converter. For example, at 600 K, the catalytic converter operates at 100% effectiveness, at 523 K—at 50%, and its effectiveness is drastically reduced above 700 K. The cold temperature of the exhaust gasses reduces performance of catalytic converter. The high temperature of the exhaust gasses reduces performance and working life of the catalytic converter. Therefore, the temperature of the exhaust gasses must be maintained in the limited range and, furthermore, the backpressure in the exhaust gas system should be low. The current method of reducing temperature of the outgoing exhaust gasses and of keeping backpressure in the current exhaust manifold low, involves expending gasses in the exhaust system. More specifically, the exhaust manifold, muffler, and exhaust pipes are designed to provide two to four times more volume than a single cylinder.

Other factors that reduce thermal efficiency of the Otto heat engine are starting and idling statuses of engines of vehicles. Because the torque of the Otto heat engine at low RPMs is negligible, the Otto heat engine's thermal efficiency is reduced when starting and keeping the engine in the idling state. The operation of the current Otto heat engine demonstrates that during the power-stroke in the cylinder 1 the mixture of fuel and air combusts, and the realized heat of this combustion reaction Qp1 pushes piston down, and through the connecting rods is converted into mechanical energy in the phase of rotating its own crankshaft Wcr, see FIG. 2b. Qp1=Wcr+Qw1=W1+(W3−W4)+W2+Qw1. Where: Qp1—the realized heat of the combustion reaction of the compressed mixture of the fuel and air from the power-stroke in the cylinder 1; Qw1—total heat energy losses through the wall in the cylinder 1; Wcr—mechanical energy on the crankshaft created during the power-stroke in the cylinder 1; W1—useful mechanical energy of the crankshaft; W2—mechanical energy for maintenance needs to maintain devices, such as pumps, a fan, ignition system and a generator; W3—mechanical energy for other maintenance needs, i.e. to maintain the intake Qi3, compression Qc4, and exhaust Qex2 strokes. In order to compress gasses by the mechanical energy of the crankshaft W3, the mechanical energy needs to be partially converted back into the phase of hot compressed mixture of fresh fuel and air in cylinder as Qc4. Then during power-stroke Qp4, the heat energy is converted back to the crankshaft Wcr1 as mechanical energy W4.

FIG. 2c illustrates thermodynamic cycle of the Otto engine as a function of temperature. Assume: b—the temperature at the end of the input-stroke; d—the temperature of the compressed mixture of the fuel and air at the end of the compression-stroke; f—the maximum temperature is created during the power-stroke; (f-g)—the heat energy is converted into mechanical energy during the power-stroke; g—the temperature of exhaust gasses at the end of power-stroke; h, k, and l—the temperatures of the unavoidable exhaust products at the end of exhaust-stroke. The energy that is needed to push out the unavoidable exhaust gasses varies as can be seen on the described curves (g-h, g-k, g-l) and depends on the load, the speed of rotation of the crankshaft of the Otto heat engine, and on the energy needed to keep the power of the crankshaft constant. In this example, curve (g-k)—the temperature of the best performance of the catalytic converter; the temperature below curve (g-l) and over curve (g-k) of the worst performance of the catalytic converter. The temperature of combustion reaction during the power-stroke should be enough to compensate: useful mechanical energy; maintenance energy need for inputting, compressing and exhausting strokes; heat energy losses through the walls; heat energy losses by friction; oil/water pumping; and spark plug firing.

The above analysis demonstrates that power and exhaust strokes last through one crankshaft rotation and input and compression strokes needs a second crankshaft rotation. In other words, in the current Otto heat engine these two independent thermodynamic cycles are combined through the crankshaft in one unit and presented as the four-stroke thermodynamic cycle. Its four-stoke thermodynamic cycle is maintained by two crankshaft rotations. The need for two crankshaft rotations lowers the thermal efficiency of the heat engine.

The present thermodynamic cycle method permits to increase the thermal efficiency of heat engines by extracting compression-stroke from the current thermodynamic cycle and by preparing the compressed air by a separate compressor. Furthermore, the heat engines increase the thermal efficiency and reduce consumption of fossil fuel by utilizing the wind-water-tide-wave kinetic energies in their processes of compressing air and pushing out exhaust products. I will refer to this as a hybrid thermodynamic cycle (HTC) in the following text.

FIG. 2d illustrates process of integrating two thermodynamic cycles. In the present drawing mechanical energies W3 and W6, used for compression of gases and exhausting of exhaust product, is independent from the crankshaft mechanical energy. It is now derived from the renewable energy sources, and it is used to rotate an external compressors. The present method of separating the compression and exhaust strokes and power strokes permits to convert a current four-stroke cycle Otto heat engine into a three or two-stroke cycle heat engine, thus eliminating all energy losses which arise from inputting and compressing the fuel and air mixture, reducing heat energy losses belonging to the power-stroke and reducing/eliminating heat energy losses belonging to the exhaust strokes. Having an independent process of compressing the fuel and air mixture and pulling out the exhaust product allows the present heat engine to operate even with one cylinder. For best performance two-stroke cycle one cylinder heat engine needs: exhausts products to push out by the kinetic energy of the flywheel, which is connected to the crankshaft; exhausts products to pull out by the external mechanical energy W6; and the fuel and air mixture to compress by the external mechanical energy W3. The external mechanical energies W3 and W6 are powered by renewable kinetic energy.

The thermodynamic cycle of the present one cylinder heat engine, see FIG. 2d, includes input (Qi1), power (Qp1) and exhaust (Qex1) strokes. Qp1=Wcr1+Qw1=W1+W2+W5+Qw1 or Qp1+W3+W6+Qw1=W1+W2+W3±W5+W6+Qw1. Where: Qp1—the realized heat of the combustion reaction of the compressed mixture of the fuel and air from the power-stroke in the cylinder; Qw1—heat energy losses through the wall; Wcr1—mechanical energy on the crankshaft created during the power-stroke; W1—useful mechanical energy of the crankshaft; W2—mechanical energy for maintenance needs to maintain devices, such as pumps, a fan, ignition system and a generator; W5—mechanical energy for maintenance needs to maintain kinetic energy of the flywheel; W3—external mechanical energy is made the compressed fuel and air mixture; W6—external mechanical energy is pulled out the exhaust products. The thermodynamic cycle of the external compressor W3 includes two strokes: the input (Qi3) and the compression (Qc4) strokes. The present thermodynamic cycle involves the following steps:

1. The compressed mixture of the fuel and air is prepared in advance by the compressor W3 and is then passed into the cylinder heat engine by means of input-stroke Qi1.

2. During the power-stroke (Qp1) the mixture of fuel and air combusts and the realized heat of the combustion reaction is converted into mechanical energy in the phase of the heat engine crankshaft rotation Wcr1.

The mechanical energy (Wcr1) feeds, for example, wheels of the vehicle (W1), a pump, fan, and spark plug ignition system (W2), and a flywheel (W5). The kinetic energy of the flywheel allows passing the compressed mixture of the fuel and air into the cylinder and pushing out the exhaust products from the cylinder. It is possible to additionally increase the thermal efficiency of the heat engine and to reduce consumption of fossil fuel by involving the external mechanical energy W3 and W6 in the inputting and exhausting strokes. In the present diagram the external mechanical energies W3 and W6 are derived from the wind-water-tide-wave kinetic energies. Mechanical energy W3 pushes the compressed air into a cylinder. Mechanical energy W6 pulls the exhaust products out from the cylinder. In the graphical representation of FIG. 2c its inputting and exhausting processes are illustrated by the temperature (m-n) and (g-r) respectively. The temperature of the compressed air depends on the external mechanical energy W3 and varies from the temperature (m) to the temperature (d). Where: m—the temperature of compressed fuel and compressed air mixture at the start of the input-stroke and r—the temperature of exhaust products at the end of exhaust-stroke. The external mechanical energy W6 reduces the exhaust temperature from the temperature (Tg) to the temperature (Tr) at the end of the exhaust stroke. Furthermore, the external mechanical energy W6 permits to maximally utilize the exhaust temperature (g-r) by the gas turbine. The involved external mechanical energies W3 and W6 are derived from the wind-water-tide-wave kinetic energies allow converting a three-stroke thermodynamic cycle into two-stroke thermodynamic cycle. The HTC permits the present hybrid heat engine to operate, such as the Otto and Diesel heat engines.

The above analysis demonstrates that it is possible to make real improvements to any of the current combustion heat engines by a proposed method of making compression, power, and exhaust strokes as independent processes and integrating them in the HTC, and by combining fuel heat and renewable kinetic energy.

### Features of the Renewable Energies

Following is the description of various renewable energies, including solar radiation and wind, wave and tide kinetic energies.

Renewable energy, such as wind kinetic energy, depends on the time of the day, the season, location and elevation above the ground. The best sites for wind turbines are coastlines and mountain passes. The best season for creating a strong wind is the wintertime. Power that may be extracted from the wind is proportional to density of air, rotor diameter to the second power and wind speed to the third power. Solar radiation depends on the time of the day, the season, on overcast and on the location. The best season for using solar radiation is the summertime (long day). Solar radiation is variable during the day. On a cloudy day, efficiency of conversion of solar energy into heat energy is low, and on a clear sunny day efficiency of its conversion is high. The sun radiates about 1.0 kW of power per square meter of surface of the earth atmosphere on a clear day. Combustion of 1 kg of fossil fuel produces heat energy 40-50 MJ. Renewable energy sources, such as low-frequency wave kinetic energy has annual average of a wave power, for example, in North Atlantic Ocean of about 50 kW per meter. The best location for a wave power plant is several miles offshore. (The wave of the ocean loses energy in shallower water. It means shore-based power plants alone produce electricity with high capital cost, low efficiency and are used only as local electricity producers). The offshore low-frequency wave energy power plants (farms) would cover large areas of the ocean. Different densities of energy content in fossil fuel and in renewable energy sources require a new conception of energy conversion system in order to increase energy production efficiency.

There need to be many steps involved in order to produce mechanical energy by current heat engines including a mining and extractive industries, refine oil industry, transportation industry, which includes trains, ships, trucks, oil and gas lines. Furthermore, theoretically, in order to decrease pollution and its effect on the environment, there needs to be a system in place to return pollutants and carbon dioxide under ground to complete the current thermodynamic cycle of conversion heat energy of fuel into the mechanical energy. This would further increase the cost of using the fossil fuel.

In order to produce mechanical energy by the present hybrid energy system there need to be a lot of land, coastlines, and a large area of the ocean surface. The capital cost of the present hybrid energy system, which uses renewable energy sources, is higher than the capital cost of the power plant, which uses fossil fuel. Furthermore, the present hybrid energy system as a primary energy producer needs an air lines for transmitting the compressed air, air storages for keeping the compressed air, and thermal storages for keeping thermal energies. In addition, the present hybrid thermodynamic cycle is more inertial than the current combustion (explosion) reaction thermodynamic cycle. Furthermore, the present hybrid energy system as a primary energy producer needs to combine predictable renewable energy sources, such as tide-wave of the ocean, water of rivers, wind of coastlines and unpredictable renewable energy sources, such as wind (mountain passes) and solar radiation. Above disadvantages of using the present hybrid thermodynamic cycle method and the hybrid energy system based thereon, such as inertia of the hybrid energy system, capital cost, a need for a lot of land and ocean surface is compensated by a lot of benefits, which include but not limited to:

1. The surrounding air, which is used in the present hybrid energy system as a working substance, permits to integrate solar and combustion thermodynamic cycles.

2. The present hybrid thermodynamic cycle method permits to use all kinds of renewable kinetic energies such as wind, water of river, tide and wave of the ocean and to combine them and to convert them into heat energy and standardized compressed air/oxygen. The standardized compressed air/oxygen is delivered to the customers by passing through the air line or special tanks on wheels.

3. The present hybrid thermodynamic cycle method permits to make non-polluting hybrid energy systems, which feeds by all kinds of renewable kinetic energies.

4. The present hybrid thermodynamic cycle method permits to increase the thermal efficiency and operating time of the present hybrid energy system by storing solar radiation and the standardized compressed air in the thermal and air storages, and then at nighttime, or on cloudy days, or during peak hours, its stored heat energy and the standardized compressed air are returning to the hybrid energy system.

5. The unavoidable heat energies in the phase of hot compressed air are disposed of without paying penalty to the ecological system.

6. The same amount of electrical energy produced by the present hybrid non-polluting wind-solar-water-tide-wave systems is cheaper and more efficient than electrical energy produced by the current wind, solar, water of river, tide and wave of the ocean energy systems combined.

7. The present hybrid heat engine, which uses oxygen as oxidizer in the combustion process, is a low emission heat engine. The carbon dioxide with pollutant extracts from exhaust products, cools down to the compressed liquid or gaseous phases and then is disposed by disposal stations. Another approach is to heat carbon dioxide and other pollutants to the optimal temperature for catalyzing process by solar radiation and to pass it into the atmosphere.

8. By combining predictable and unpredictable renewable energy sources, fossil fuel, as well as using thermal and air storages the operating time of the present hybrid energy system is increased up to 100%. Therefore, the present hybrid energy system can be used as a primary electrical energy producer.

9. The present hybrid thermodynamic cycle method permits the present neighborhood hybrid power plants to reduce/eliminate electrical and heat energies consumption from centralized power plants.

10. The present thermodynamic cycle method permits the current solar electrical power plants to reduce impact of the intermittently cloudy days by changing working substances from water to gasses. One of the biggest problems in the current solar electrical power plant, which uses water as a working substance, are the intermittently cloudy days, during which a temperature may never get to the working state of about 400 K. In the present power plant working substances, such as compressed gasses are heated by the solar radiation, and then its heat energy is converted into mechanical energy by a piston internal combustion heat engine and a gas turbine heat engine. Advantage of using a piston heat engine is that the piston heat engine has a higher compression ratio, torque, and thermal efficiency than that of a gas turbine. The advantage of a gas turbine is that it has a smaller size and weight.

11. The present hybrid thermodynamic cycle method permits cities to widely use neighborhood hybrid (solar) power plants. Cities don't have enough unused land for making large solar power plants. They only have a lot of parking spaces; roofs belonging to stores, manufacturing areas, businesses, and homes, which can be used by the neighborhood hybrid power plants.

12. The present hybrid thermodynamic cycle method permits to increase efficiency of the present neighborhood hybrid power plant by producing and utilizing electricity and an ecologically clean hot exhaust air simultaneously.

13. The present hybrid thermodynamic cycle method permits to increase efficiency of the present hybrid energy system by making mobile hybrid wind-natural gas or tide-wave-natural gas (or any other combination of above listed fuel sources) power plants.

14. The present hybrid thermodynamic cycle method permits to increase efficiency of the current Hydraulic electrical power plant by making the compressed air and oxygen at nighttime or off-peak hours and keeping them in the air and oxygen storages. During sunny daytime the compressed air is heated by the solar radiation and then this heat energy is converted into electrical energy by the heat engine-generator. The already made oxygen is used as an oxidizer in the combustion process. The total efficiency of energy conversion system using the combination of solar radiation, river water's kinetic energy, and the realized heat of combustion reaction is high. Furthermore, its energy conversion process is achieved without paying penalty to the ecological system. Another effective way to increase efficiency of the present hybrid energy system and reduce impact on the ecological system is to use compressors along the rivers' paths. Typically kinetic energy of water is low to produce electricity profitably. In order to produce electricity by the current hydraulic turbine-generator method profitably dams need to be placed on the river. (The dams increase potential energy of water). However, river water's kinetic energy is enough to make the compressed air profitable along the river path. Multistage air compressors (with water heat energy exchangers) isothermally compress air, thus minimizing energy consumption. Therefore, it is enough to use a river channel or a portion of a river that runs through a canal or a penstock to produce compressed air, without a need to build dams. On average, there is a lot of water energy of rivers in many regions of the country, which can be used for air compression. Furthermore, the low speed of air compression and the use of river water to cool bodies of compressors permit to eliminate the need for oil as lubricant. Furthermore, the compressed air made along river path will be close to the customers.

The steps of producing electrical energy by sun radiation and water of river are: Kinetic water energy is converted into mechanical energy by the water turbine. The compressor then converts its mechanical energy into heat energy in the phase of hot compressed air. Its heat energy is then converted into mechanical-electrical energy by a heat engine-generator. During off-peak hours the hot compressed air cools down and is kept in the air storage. During sunny daytime the solar radiation heats the compressed air and its heat energy is converted into mechanical energy. Also during sunny daytime solar radiation is converted into heat energy and is then collected in the thermal storage. At nighttime or on cloudy days, the compressed air is heated by the heat energy which is taken from the thermal storage and/or by the fossil fuel energy. The temperature of the clean exhaust air is utilized as heat energy, for example, to warm air and water in homes. The thermal efficiency and operating time of the present hybrid energy system is high. Furthermore, the combined solar-water-fuel energy sources can be used as a primary electrical energy producer

15. The present hybrid wind power plant increases the efficiency of conversion of wind energy into electrical energy by combining current direct and present indirect thermodynamic cycles.

16. The present hybrid thermodynamic cycle method permits to combine solar radiation and kinetic ocean tide and wave energies. Tides are generated by a combination of gravity and the motion of the Earth, the moon and the sun. Two high tides and two low tides are created every 24 hours. The coastal lines are thousands of kilometers around the Earth. The forces of tides and waves are significant. The present hybrid thermodynamic cycle method permits to use tidal and wave energy not only on the coastal lines but also in the ocean. During sunny daytime compressors convert low oscillated kinetic energies of tides and waves into heat energy, then its heat energy directly passes into the solar heat energy exchanger, and is additionally heated by the solar radiation. Then its combined heat energy is converted into mechanical-electrical energy by the hybrid heat engine-generator. The compressed air produced during off-peak hours is cooled down and kept in the air storages. During sunny daytime the solar radiation is also converted into heat energy to be kept in the thermal storages. Efficiency of the hybrid solar-tide-wave energy conversion system during sunny daytime is high. During nighttime or on cloudy days the compressed air is heated by the heat energy contents from the thermal storages or by the fuel heat energy. Then its heat energy is converted into electrical energy by the heat engine-generator. The benefit of integrating the predictable kinetic tides and waves of the ocean, unpredictable solar radiation energy, and the realized heat of combustion reaction energy is the increase in the operating time of the present hybrid energy system up to 100%. The hybrid thermodynamic cycle method permits the hybrid solar-tide-wave-fuel power plants to produce not only electrical energy but also a high quantity of the compressed air, which is used as a working substance by the neighborhood power plants, air and combustion engines.

A hybrid thermodynamic cycle is a method of integration (collection, operation, conversion, transmission, and storage) of incompatible types of energy, such as fossil fuel, renewable solar radiation, kinetic wind, river water, and ocean tide and wave energies; utilization of a surrounding air as an intermediate working substance; reduction of fossil fuel consumption; maximum utilization of renewable energy sources; increase of hybrid energy systems efficiency and operating time; transforming energy conversion systems from supplemental to primary energy producers.

A present hybrid thermodynamic cycle is a two-phase method of converting renewable energy into mechanical energy. First phase of converting renewable energy into mechanical energy includes conversion of low oscillating renewable kinetic energy into heat energy, preparing standardized (cooled) compressed air, collecting and storing renewable solar radiation and kinetic energy in the form of heat energy and standardized compressed air. Second phase of converting renewable energy into mechanical energy includes conversion of heat energy into mechanical energy in the form of high spinning heat engine's shaft. A hybrid energy system is based on a hybrid thermodynamic cycle and is comprised of solar-water, solar-wind, solar-tide, solar-wave, wind-wave-tide, wind-tide, wave-tide, wind-water, solar-wind-water, solar-wind-tide, solar-wind-wave, solar-wind-tide-wave, solar-water-fuel, solar-wind-fuel, solar-tide-fuel, solar-wave-fuel, wind-wave-tide-fuel, wind-fuel, tide-fuel, water-fuel, wave-fuel, wind-tide-fuel, wind-water-fuel, solar-wind-water-fuel, solar-wind-tide-fuel, solar-wind-wave-fuel, and solar-wind-tide-wave-fuel hybrid power plants. The hybrid heat engine at its core integrates incompatible energies and converts them into mechanical energy in the phase of rotating crankshaft of the piston heat engine and high spinning shaft of the gas turbine. The basics of the present hybrid energy system includes wind-water-tide-wave kinetic energy collectors, compressors, solar radiation collectors, air and water heat energy exchangers, air and thermal storages, hybrid heat engines, electrical generator, air and electrical transmission lines. The wind-water-tide-wave kinetic energy collectors convert renewable kinetic energies into mechanical energies in the phase of low spinning shaft of the mechanical collectors. The compressors convert wind-water-tide-wave mechanical energies into heat energy and into compressed air/oxygen. Heat energy converts into mechanical energy in the phase of a high spinning shaft of a heat engine. The solar heat energy exchanger converts solar radiation energy into heat energy. The air and water heat energy exchangers convert heat energy into the standardized compressed air. Electrical generators convert mechanical energy into electrical energy. The compressed air/oxygen and solar radiation are stored in air and thermal storages. The compressed air and electrical energy are transmitted through the air and electrical lines.

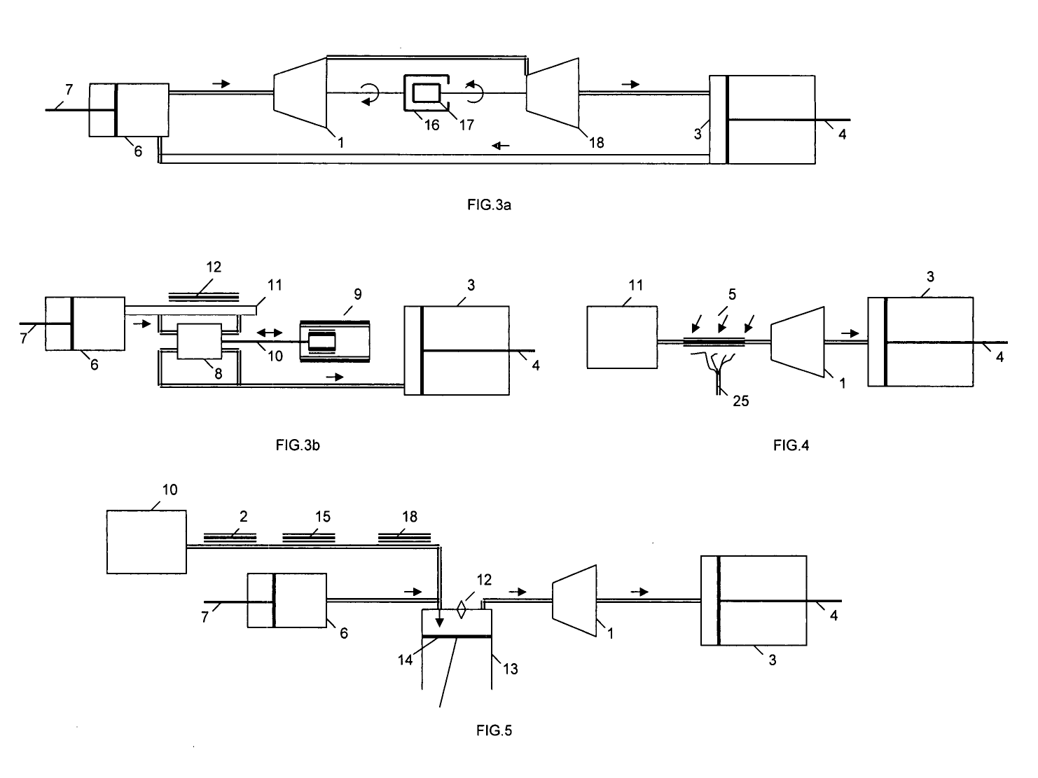

FIG. 3a schematically illustrates the thermodynamic cycle of conversion of renewable kinetic energies into mechanical energy in the phase of the gas turbines' rotating shafts. In this embodiment the hybrid energy system combine gas turbines, compressors, and a generator. The thermodynamic cycle of the hybrid heat engine is as follows: the renewable kinetic energies pass through the compressors 6 and 3 and gas turbines 1 and 18, and are converted into mechanical energies in the phase of clockwise and counterclockwise high speed rotating shafts of the gas turbines. The renewable kinetic energy pass through the rod 4 of the cylinder 3 as the vacuum-stroke sucks exhaust air from the gas turbine 18, and then the compression-stroke pushes the exhaust air into the cylinder 6. The compressor 3 can lower the exhaust air temperature to either below or above the temperature of the surrounding air. In the mode when the temperature of the exhaust air is above the surrounding air temperature, the air heat energy exchanger is installed between the gas turbine 18 and the compressor 3. Mechanical energies in the phase of clockwise and counterclockwise high speed rotating shafts of the gas turbines convert into electrical energy by the generator. Clockwise and counterclockwise high-speed rotating shafts of the gas turbines are coupled to the coil armature 17 and magnetic field 16. The electrical output is governed by the Faraday's law. The magnetic field is created by permanent magnets or by electromagnets. Its kinematical scheme permits the present hybrid energy system to maximally convert renewable kinetic energy into mechanical-electrical energy. Its kinematical scheme also permits to reduce the inlet temperature of the gas turbine. Furthermore, the inlet temperature reduction is achieved without increasing sizes of the gas turbines and without reducing hybrid heat engine thermal efficiency.

FIG. 3b schematically illustrates the thermodynamic cycle of conversion of renewable kinetic energies into mechanical energy in the phase of linear motion of a piston of a linear free piston engine. In this embodiment the hybrid energy system combines a linear free piston engine 9, compressors 3 and 6, heat energy exchanger 12, and a linear generator 9. Inside of a cylinder of a linear free piston engine is installed springs (not shown). The thermodynamic cycle of the hybrid heat engine is as follows: the low oscillating renewable kinetic energies pass through the compressors 6 and 3, and are converted into mechanical energies in the phase of force and back of moving the piston of the linear free piston engine 8. The renewable kinetic energy passes through the rod 7 of the cylinder 6 as the compression-stroke pass the compressed air into the heat energy exchanger 11. In the heat energy exchanger 11 the compressed air is heated by the solar radiation 12, and then its heat energy pushes piston of the free piston engine 8 at the power-stroke. The renewable kinetic energy passes through the rod 4 of the cylinder 3 as the vacuum-stroke sucks exhaust air from the linear free piston engine 8. The compressor 3 can lower the exhaust air temperature to either below or above the temperature of the surrounding air. The present embodiment permits a linear free piston engine to operate with or without ignition of the fuel. The mode of operating with or without ignition of the fuel depends on the compression ratio in the cylinder, the amount of kinetic and solar energies present, and load. Furthermore, the present embodiment permits a current three-stroke cycle of a linear free piston engine to convert into a present two or one-stroke cycle of a linear free piston engine. Furthermore, its kinematical scheme permits the present hybrid energy system to convert renewable kinetic energy into electrical energy by coupling the linear free piston engine 8 with the linear generator 9 through the rod 10. Furthermore, its embodiment also permits to reduce the inlet temperature of the linear free piston engine. Furthermore, the inlet temperature reduction is achieved without increasing sizes and without reducing thermal efficiency of the free piston engine. The present two or one-stroke cycle of the linear free piston engine is operated with conjunction of springs. In the present embodiment: force and back moving piston of a linear free piston engine means the one cycle; pushes a piston and sucks exhaust gas from a cylinder means a power-stroke; the mass of the compressed air, which passes into a cylinder of the linear free piston engine, depends on the Reynolds number, and is regulated by a computer.

FIG. 4 illustrates the process of integrating kinetic, solar and fossil fuel energies. The air plant 11 is prepared the compressed air. The compressors of the power plant 11 are converted kinetic renewable energies into the phase of compressed air during off peak hours of hybrid power plant operation. Then the compressed air from the air plant 11 passes into the heat energy exchanger 5. In the heat energy exchanger 5 the compressed air is heated by the solar radiation and/or fossil fuel heat energies 25, and then its heat energy passes into the gas turbine 1. The gas turbine 1 converts this heat energy into mechanical energy. The renewable kinetic energy passes through the rod 4 of the cylinder 3 as the vacuum-stroke sucks exhaust air from the gas turbine 1. The compressor 3 can lower the exhaust air temperature to either below or above the temperature of the surrounding air. In the mode when the temperature of the exhaust air is above the surrounding air temperature, the air heat energy exchanger is installed between the gas turbine 1 and the compressor 3.The unavoidable heat energy in the phase of non-polluting hot exhaust air can potentially be used, for example, to warm air and water inside the buildings. Its kinematical scheme permits the present hybrid heat engine to convert into mechanical energy the combined energies of solar radiation, fuel heat, and renewable kinetic energy.

FIG. 5 illustrates the process of integrating renewable kinetic energy and fuel heat energy.

For process of combustion to occur three things must be present: fuel to be burned, a source of oxygen, and a source of heat. During oxidation of the fuel mixture, heat and exhaust products are released. For example, during combustion of methane with oxygen, CH₄+2(O₂+3.76)N₂→CO₂+2H₂O+7.52N₂, the reaction produces water, carbon dioxide and pollutants, such as nitrous oxides (NOx) and Carbon monoxide (CO). The formula of combustion reaction doesn't tell us anything about fuel and oxygen conditions. For example, for the current thermodynamic cycles, such as Otto, Diesel, or Brayton, fuel is prepared in advance and oxygen is prepared by compressing air during the compression-stroke in the cylinders of the Otto or Diesel engines or compressors coupled to the Brayton gas turbines. Heat energy, that is needed for compressing and pushing out exhaust products, is obtained from the fossil fuel. In the present hybrid solar-combustion thermodynamic cycle fuel and air/oxygen/carbon dioxide are prepared in advance. Process of making oxygen by using membrane gas separation technology is cheap and needs low energy consumption for generating enriched quantity of oxygen. Carbon dioxide can be used in a combustion process as a temperature reduction substance. Furthermore, energy, which is needed for air/oxygen/carbon dioxide compression and exhaust products expulsion, is taken from the renewable kinetic energy sources. Furthermore, this process is done polytropically. The rest of carbon dioxide, together with other pollutants, can be disposed of underground or can be heated by the solar radiation to the temperature of best performance of the catalytic converter. This way of disposing defines a non- or low-polluting energy system.

The present hybrid heat engine includes compressors 3 and 6, piston combustion engine 13, and gas turbine 1. In this embodiment, the compressor 6 compresses mixture and the compressor 3 suck out the exhaust gasses. The compressors are powered by renewable kinetic energies. The sequence of this hybrid thermodynamic cycle is: the compressor 6 compresses fuel and oxygen/carbon dioxide mixture and passes it into cylinder 13; spark plug 12 ignites this mixture during the power stroke; the realized heat of combustion reaction pushes piston 14 down and through the connecting rods rotates a crankshaft; during the exhaust-stroke gases from the cylinder 13 pass into gas turbine 1, which converts heat energy into mechanical energy, and then compressor 3 sucks the exhausted gases from the gas turbine 1 and ejects them out. When compressors 3 and 6 are disabled (if kinetic energy is not available), the compressed air/oxygen needed for the combustion reaction is taken from the air/oxygen storage 10. This compressed air is first preheated in the heat energy exchanger 2 by the temperature of the surrounding air and subsequently in the heat energy exchanger 18 and 15 by the wall and exhaust gasses temperatures.

The present embodiment permits a piston heat engine to operate with and without ignition (Diesel cycle) system. The mode of operating with or without ignition depends on the compression ratio in the cylinder and the amount of kinetic energy present.

Benefits of the above hybrid heat engines based on the present hybrid thermodynamic cycle are a reduction of heat energy consumption taken from fossil fuel and high thermal efficiency of the present hybrid heat engines. For example, according to the average wind speed in the U.S. of about 4.4 meters per second, the wind power plants cannot operate profitably and, furthermore, annual average wind speeds of 5 m/s are required for connecting wind power plants to air grid and, furthermore, wind speed of 6.2 m/s is required for wind power plants to operate profitably. The present hybrid thermodynamic cycle and the hybrid heat engine based thereon resolves this wind speed gap conflict in the hybrid wind power plant by utilization of fossil fuel energies in addition to kinetic wind when needed.

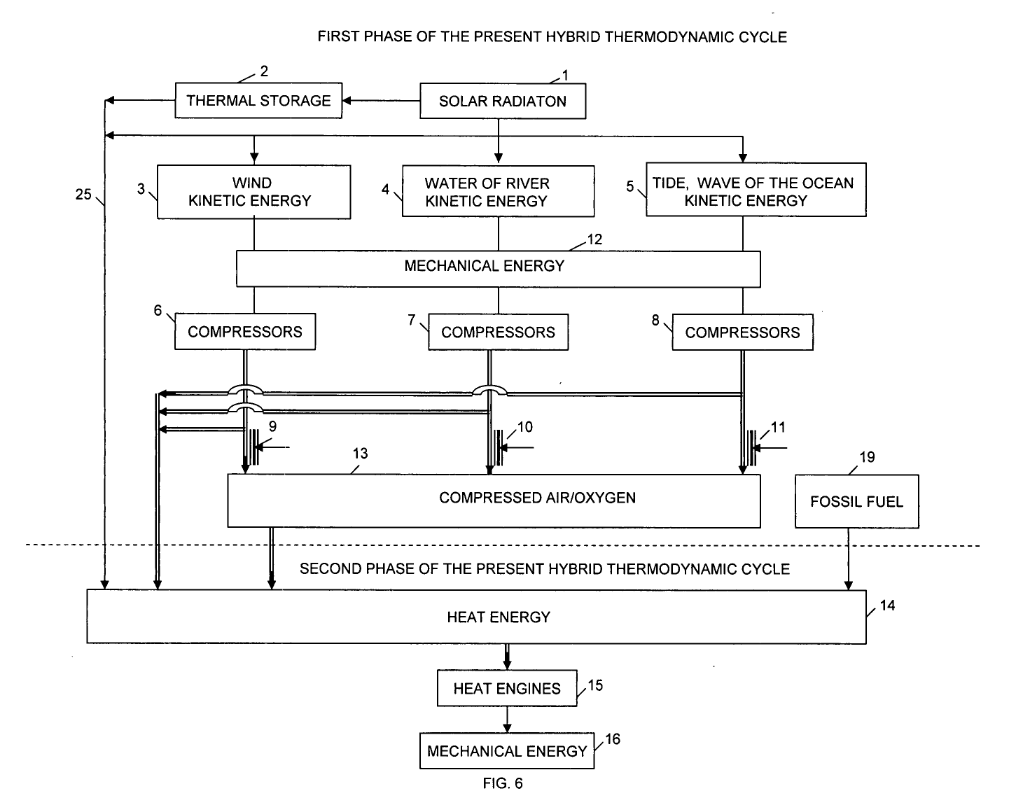

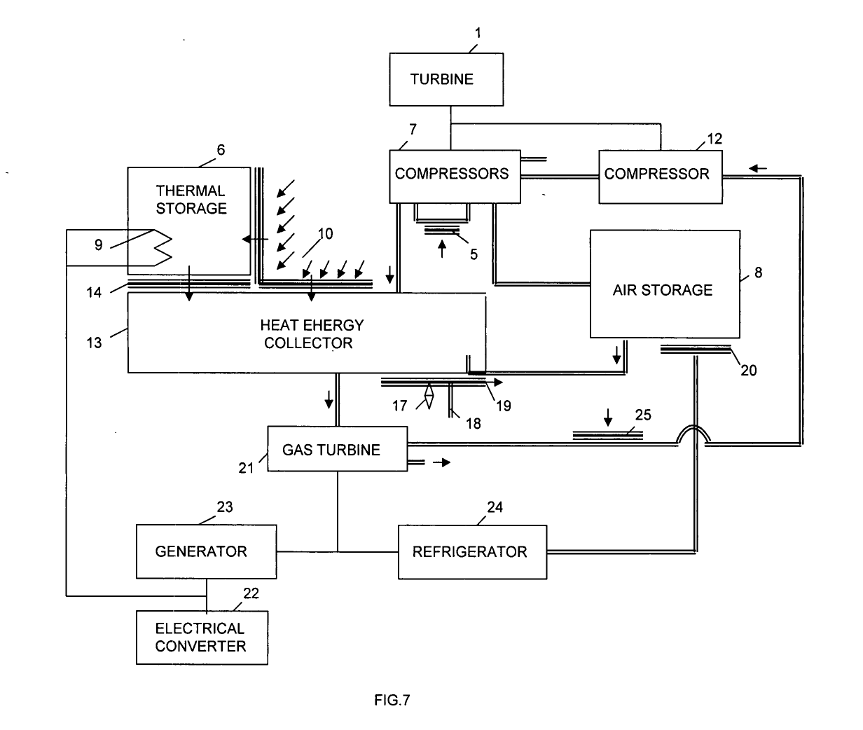

FIG. 6 schematically illustrates the integrated solar and combustion reaction thermodynamic cycles.

1. During the first-phase of the present hybrid thermodynamic cycle the products of solar radiation 1, i.e. the wind 3, water of river 4, and tide-wave of the ocean 5 kinetic energies, collect in the phase of mechanical energies 12. Then wind 6, water of river 7 and tide-wave of the ocean 8 compressors convert mechanical energies into heat energy 14. Processes of heat extraction from the hot compressed air in the heat energy exchangers 9-11, of compressed air/oxygen production, of collecting and storing such air/oxygen in the air/oxygen storage 13 are also part of the first-phase of the present thermodynamic cycle.

2. During the second-phase of the present hybrid thermodynamic cycle compressors 6-8, solar radiation 1, solar heat energy from the thermal storage 2, and realized heat of combustion reaction of fossil fuel 19 in the heat energy exchangers 14 produce heat energies which are combined and converted into mechanical energy 16 by heat engines 15.

Below are some examples that illustrate the operation of the present hybrid thermodynamic cycle.

FIG. 7 schematically illustrates the operation of the hybrid power plant. The present hybrid power plant produces electrical energy by utilizing solar radiation energy, fuel heat energy, and renewable kinetic energies, such as wind, water, tide, and wave. In this embodiment the hybrid power plant includes: turbine 1 (wind, water, tide, and wave), multistage compressor 7 with air heat energy exchangers 5; compressor 12, heat energy collector 13, combustion heat energy exchanger 19, natural gas pipe 18, spark plug 17, gas turbine 21, resistors 9, solar heat energy exchanger 10, air storage 8, thermal storage 6, thermal heat energy exchanger 14, refrigerator 24, generator 23, and electrical converter 22. Multistage compressor system is composed of the compressors 7 and air heat energy exchangers 5. The compression ratio of a multistage compressor is proportional to the compression ratio of each stage. The present multistage compressor operates in the compressed air (polytrophically) and heat energy (adiabatically) modes.

When renewable kinetic energy is available the operation of the hybrid power plant is as follows: the turbine 1 converts renewable kinetic energy into mechanical energy. Then the compressor 7 converts mechanical energy into heat energy in the phase of hot compressed air. At the beginning of the operation the compressor 7 compresses the surrounding air, and then the heat energy collector 13 collects the hot compressed air and passes it to the gas turbine 21. In the present embodiment the hybrid thermodynamic cycle entails conversion of renewable kinetic energy into mechanical energy in the phase of low speed rotating shafts of the compressors, then conversion of mechanical energy into heat energy in the phase of hot compressed air, and then conversion of heat energy into mechanical energy in the phase of high spinning shaft of the gas turbine 21. The shaft of the gas turbine is coupled to shafts of the generator 23 and refrigerator 24. The generator 23 converts mechanical energy into electrical energy. Compressor 12 sucks the exhaust air out from the gas turbine during the vacuum-stroke and then passes the exhaust air into compressor 7 during the compression-stroke. The compressor 7 compresses the exhaust air and then returns it to the heat energy collector 13. When electrical energy consumption is low or kinetic energy availability is high, the multistage compressor 7 partially passes the compressed air into the air heat energy collector 13 and partially passes through the air heat energy exchanger 5 to the air storage 8. The refrigerator 24 cools compressed air contents in the air storage 8.

During sunny daytime and when renewable kinetic energy is present the operation of the hybrid power plant is as follows: The turbine 1 collects and converts renewable kinetic energy into mechanical energy; the multistage compressor 7 partially passes the compressed air into the air heat energy collector 13 and partially passes through the air heat energy exchanger 5 to the air storage 8. The refrigerator 24 cools compressed air contents in the air storage 8. Additionally, the heat energy exchanger 13 collects heat from the solar radiation and then its combined heat energy passes into the gas turbine 21. The solar radiation is collected by lenses or mirrors in the solar heat energy exchanger 10, and it is converted into heat energy. The gas turbine 21 converts its heat energy into mechanical energy. Electrical energy is made by the generator 23 is distributed to local customers or is connected to the electrical grid (not shown) through the electrical converter 22. The extra electrical energy is sent to the thermal storage 6, where it is converted back into the heat energy by resistors 9. Compressor 12 returns the exhaust air back into the system. During nighttime heat energy heats the compressed air taken from the thermal storage 6.

When availability of kinetic energy is low, or when neither kinetic nor the solar radiation energies are present the operation of the hybrid power plant is as follows: The compressed air is taken from the air storage 8 and is passed into the heat energy exchanger 13. Spark plug 17 ignites the mixture of natural gas, and the surrounding air combusts. The realized heat of fuel heats the compressed air contents in the heat energy collector 13 through the combustion heat energy exchanger 19. The gas turbine 21 converts its heat energy into mechanical energy. The exhaust air from the gas turbine 21 passes into the atmosphere or its low-pressure heat energy can be utilized in the neighborhood building for the various appliances (not shown).

Therefore, the benefit of the present embodiment is that when kinetic and solar radiation energies are available, the hybrid power plant produces electrical energy and compressed air, as well as collects solar radiation in the thermal storage. The operating time is high as a result of keeping the compressed air and the solar radiation in the air storage and thermal storage respectively.

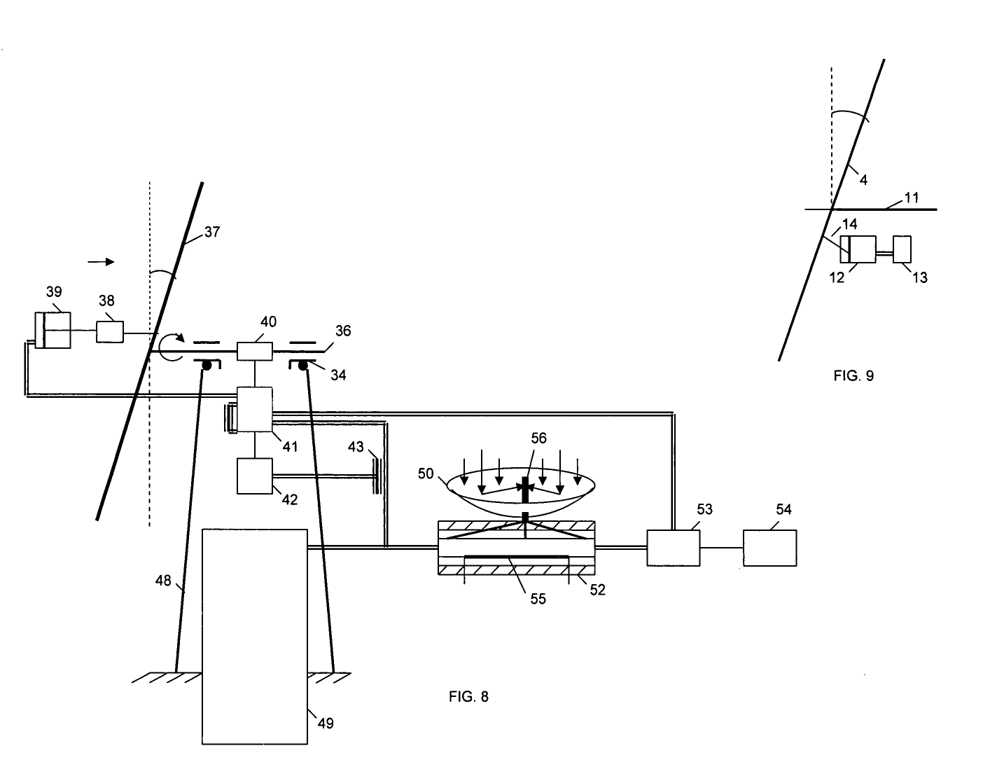

FIG. 8 schematically illustrates the basic operation of zero-pollution hybrid solar-wind power plants. The compressed air is heated by its thermal energy and collected in the thermal module 52. In the present embodiment the hybrid solar-wind power plant includes basic parts: two-blade wind turbine 37; multistage compressor 41; compressor 39; mechanical direction switch devices 38, 40; air heat energy exchangers 47; refrigerator 42; electrical generator 54; gas turbine 53; thermal module 52; tower 48; air storage 49; solar radiation collector 50; intermediate rods 56 and resistors 55. The solar radiation is concentrated by mirrors of the solar radiation collector 50 and then the concentrated solar radiation is converted into thermal energy through intermediate rods 56. The solar heat energy exchanger and heat storage are integrated into one unit, such as the thermal module 52. The present compressors operate in the compressed air and heat energy modes. In the solar heat energy exchanger the compressed air is heated by the solar radiation, and then its heat energy passes into the gas turbine 53. The gas turbine converts its heat energy into mechanical energy. The unavoidable heat energy in the phase of non-polluting hot exhaust air can potentially be used to warm air and water inside the homes and hotbed. The basic operation of the hybrid solar-wind power plant is: The two-blade wind turbine 37 converts kinetic wind energy into mechanical energy in the phase of low speed rotating shaft 36 and teetering motion, such as blades moving into and out of the plane of rotation. Then the multistage compressor 41 converts its rotational mechanical energy into heat energy or compresses air through the mechanical direction switch device 40. The compressor 39 converts kinetic energy of flip-flopping blades into heat energy or the compressed air through the mechanical direction switch device 38. The mechanical direction switch device 40 converts the rotational mechanical energy into one way rotation of shaft of compressor 41 and of refrigerator 42. The compressor 39 passes heat energy to the multistage compressor 41. In the heat mode the compressor 41 produces heat energy and then combines heat energies of compressors 39 and 41 and passes them directly to the gas turbine 53. Then the gas turbine 53, which is coupled to the gas turbine 53 of the generator 54, converts the heat energy into mechanical-electrical energy. During the sunny daytime the solar radiation is collected in the thermal module 52 through the intermediate rods 56. During the nighttime or when low wind energy is present, the compressed air is passed from the air storage 49 into the thermal module 52, then it is heated by the stored thermal energy and then the hot compressed air passes to the gas turbine 53. During low electrical energy consumption, the multistage compressor partially passes the hot compressed air into the gas turbine 53 and partially passes it into the air storage 49. Furthermore, during low electrical energy consumption, refrigerator 42 cools the compressed air and the extra electrical energy is sent to the thermal module 52, where resistors 55 convert it back into the heat energy. During the nighttime, heat energy heats the compressed air taken from the thermal storage 55. The non-polluting exhaust air from the gas turbine 53 is sucked in by the compressor 41 and/or its low-pressure heat energy can be utilized in the neighborhood homes for the various appliances (not shown). The multistage compressor 41 also helps to start-up the wind turbine. For this purpose, the compressor 41 operates as the heat engine in the following manner: the compressed air is passed from the air storage 49 into the compressor 41 where it mixes with fuel and combusts (not shown); the realized heat of the combustion reaction pushes the piston of the compressor 41 up or down. The moving piston rotates the wind turbine 37 through the mechanical direction switch device 40 and the shaft 36. The benefit of utilizing the compressor as the heat engine is that the start-up induction motor is eliminated and the time of the start-up is reduced.

FIG. 9 illustrates a process of converting teetering motion of blades into electricity. The components of this embodiment are: blade 4, compressor 12, gas turbine-generator 13, and connecting rods 14. The teetering motion of blades pushes/pulls the piston of compressor 12 through connecting rods 14. The compressor 12 converts mechanical energy into heat energy. Then the gas turbine-generator 13 converts its heat energy into electrical energy.

Benefit of the present embodiment, see FIG. 8, 9, is that when kinetic and solar radiation energies are available, the hybrid power plant produces electrical energy and compressed air, as well as collects solar radiation in the thermal storage. The operating time is high as a result of storing the compressed air and the solar radiation in the air storage and thermal storage respectively. The benefit of the present embodiment is that the efficiency of the wind power plant is increased because of utilization of all static and dynamic energy contents in the wind and by additional utilization of kinetic energy contents in the teetering motion of wind turbines blades. Its teetering motion depends on stochastic loads, which arise or drop from the fluctuated wind, and is higher when one side of the blade passes behind of the tower and another side of the blade passes at the upper level of rotating blades. The benefit of using the two-blade wind turbine compared to the three-blade wind turbine is reduction of the wind turbine system weight (blade, gearbox, and generator) in half. The use of one- or two-blade wind turbines permits to reduce the cost of the wind power plant. The current wind turbines cost roughly 40-45% of the capital cost of the wind power plants. Cost of the wind turbines depend on a blade length. For example, today, the cost of 20, 30, 40 and 50 meters long blades is about $50,000, $97,000, $230,000 and $454,000 dollars respectively. The cost of counterweights is much less expensive than the cost of blades.

The fluctuating kinetic energies always produce oscillating, and vibrating stresses, which influence mechanical and electrical devices of energy conversion systems. Above stresses reduce efficiency and performance of the current energy conversion systems. The present hybrid thermodynamic cycle permits the hybrid energy conversion system to operate under the above stresses, and, furthermore, this system operates with maximum conversion efficiency and good performance. The benefit of utilizing the surrounding air as an intermediate working substance in the hybrid energy system is that air dampens down and absorbs the fluctuating, oscillating and vibrating kinetic and mechanical energies.

The present hybrid thermodynamic cycle method permits to reduce weight and the overall cost of the present wind power plants by eliminating any aerodynamic, electronic, mechanical control systems and devices, which are used for reduction of above kinetic and mechanical stresses, by installing wind turbine farms on different levels of the tower, by making wind turbines with different lengths and weights of blades (this permits to eliminate the enforcement of the tower base which decreases the possibility of resonance), and by varying wind turbine speed by altering loads. This permits to avoid violent oscillations. All wind turbines have different masses and produce different oscillation and vibration frequencies which always differ from the tower eigenfrequency.

In the present hybrid wind power plant, the power extracted from the wind depends only on the wind variation for a typical site (Weibull Distribution), Reynolds number, the limitation to the blade tip speed (the recommended maximum blade tip speed is less than 100 m/s), the law of extracting power from the wind energy (Betz criterion, Cp=0.593), tip speed ratio, and the limitation of mechanical strength, for example, of wind turbines, generators, and compressors. The power efficiency Cp depends on the tip speed ratio. The tip speed ratio=tip speed/wind speed. The tip speed ratio depends on an angle of attack and blade setting. Furthermore, the wind turbine extracts the maximum power from the wind at the condition of maintaining the tip speed ratio in the optimal range. In the present wind turbine, it is not necessary to make thin blades as are required in the “low solidity” turbine. (Thin blades in the current wind turbines permit to increase the speed of turbine rotation. High speed of turbine rotation is beneficial to the frequency requirements of generators, efficiency, and size of gearboxes). The benefit of making thicker and wider blades is the reduction of cost of wind turbines.

In the current wind power plant, the control system limits the power drawn from the wind in order to keep the torque or frequency constant, and to prevent the generator from damage. It is possible to increase the power extracted from the wind by integrating current (direct) and present (indirect) thermodynamic cycles. Current direct thermodynamic cycle implies a direct conversion of kinetic energy into mechanical energy in the phase of the low spinning turbine shafts, which is followed by conversion of mechanical energy into electrical energy through a gearbox and a generator. The present indirect thermodynamic cycle implies conversion of kinetic energy into mechanical energy in the phase of low spinning turbine shafts, which is followed by conversion of mechanical energy into heat energy and then heat energy into mechanical energy in the phase of high spinning gas turbine shaft and then mechanical energy into electrical energy by a generator. The combined current and present thermodynamic cycles permit the wind power plant to:

Extract maximum power from the wind by utilizing static and dynamic (fluctuating) components of wind simultaneously.

Extract maximum power from the wind during on/off peak hours.

Extract maximum power from the wind by utilizing rotational and teetering motions of the wind turbine.

Increase the operating time by collecting and storing the compressed air in the air storages.

Increase the thermal efficiency by utilizing the non-polluting hot exhaust air and electrical energy simultaneously.

Eliminate any limitations to the energy conversion system, with the exception of the strength of mechanical devices, which are part of the wind power plant.

Increase swept area by installing multiple wind turbines on each tower.

The combined current (direct) and present (indirect) methods of conversion of wind energy into electrical energy permit the present hybrid wind power plant to maximally extract power from the always-fluctuating wind. The only restriction in absorbing higher wind frequencies is the width of the blades. (If the fluctuating wind frequency is higher than the optimal for the given blade width, the fluctuating wind will become turbulent on the blades and will convert from the positive force to the negative force).

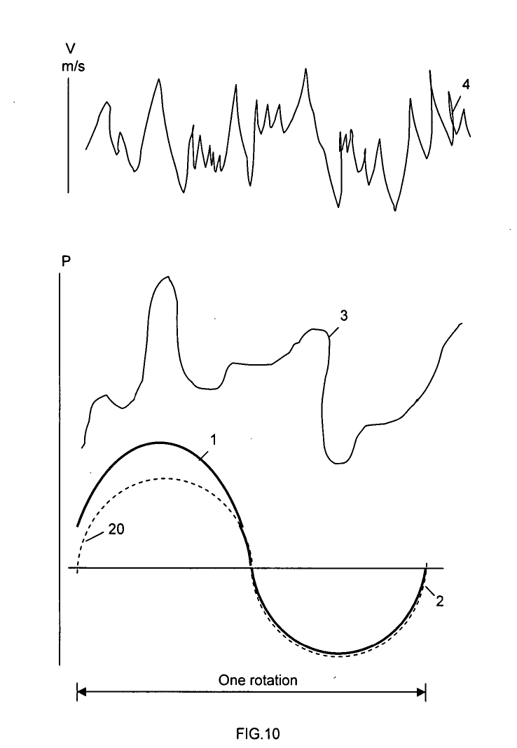

FIG. 10 illustrates the basics of extracting maximum power from the wind. In this figure, graphs 20, 4, 1, and 3 illustrate wind turbine rotation, fluctuating wind, power contents in the static wind (wind speed on the turbine hub), total power content of the wind (static and fluctuating wind) respectively. Graph 3 demonstrates a great potential of power contents in the fluctuating wind. The power extracted from the fluctuating wind also fluctuates and is, therefore, unpredictable. In order to extract the maximum power from the wind it is necessary to observe the following condition: the instantaneous energy produced (Ewind) should be completely consumed (Econsumed). Ewind-Econsumed=0, where Eload is energy completely consumed. In other words, any change of wind energy will be detected and completely realized by the energy conversion system. The present hybrid wind power plant permits to best satisfy the above condition by producing mechanical energy Em, electrical energy (Ee), heat energy (Eh), and the compressed air (Ea) Ewind=Em+Ee+Eh+Ea. The Econsumed energy is that energy which is completely consumed during on and off peak hours of wind power plant operation. During off peak hours the produced products need to be collected and stored into, for example, thermal and air storages and a flywheel. Mechanical and electrical energy is a product of direct and indirect thermodynamic cycles. Heat energy and the compressed air are products of an indirect thermodynamic cycle. The present hybrid wind power plant satisfies the above condition by loading the generators and compressors permanently. The formula of the above condition of producing and completely consuming the wind energy applies to any renewable energy:
Eproduced−Econsumed=0.

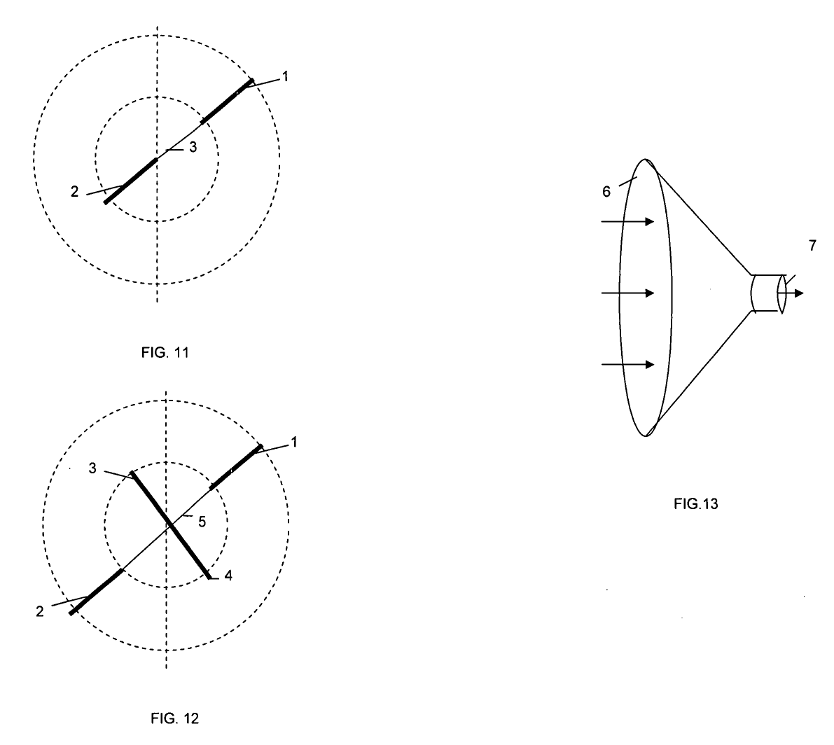

FIG. 11, 12 illustrate the present method of weight and cost reduction of wind turbines. The present method of wind turbine's weight reduction is illustrated in the following example. In the present embodiment see FIG. 11 the one blade wind turbine is assembled by connecting blade 1 to the hub of the wind turbine through the air foiled support arm 3, and by connecting blade 2 (including a counterweight) directly to the hub of the wind turbine. The present wind turbine needs to be balanced by installing a compensating counterweight equal to the support arm weight 3. The two-blade wind turbine see FIG. 12 is assembled by connecting blades 1 and 2 to the hub of the wind turbine through the support arm 5, and by connecting blades 3 and 4 directly to the hub of the wind turbine.

Assume: diameter of swept area of 30 meters; weight of a 7.2 meters long blade is about 150 kg; the support arm weights about 100 kg; weight of a Nordex 80/2500 38.8 meters long blade is about 8600 kg; and Nordex rotor has three blades. In this example, total weights of the present one- and two- and current three-blade wind turbines are about 500 kg, 800 kg, and 25800 kg, respectively. For above example, the weight of 32 wind turbines with 2 blades (25800:800) is equivalent to that of the current turbine with 3 blades. Total swept area of the present two-blade wind turbines farms is about 22608 sq. meters, and that of the current three-blade wind turbine is about 5024 sq. meters. Therefore, 32 current two-blade wind turbines have the same weight as the present three-blade wind turbine, but have a 4.5 times larger swept area.

The above example demonstrates that the present one- and two-blades wind turbines have less weight and cover a larger area than the current ones. One benefit of weight reduction of blades is that the wind turbines can catch more power from the static and dynamic wind. Furthermore, another benefit of weight reduction of blades is that it allows for an easier design and construction of multi-rotor wind power plants and for a lower overall cost.

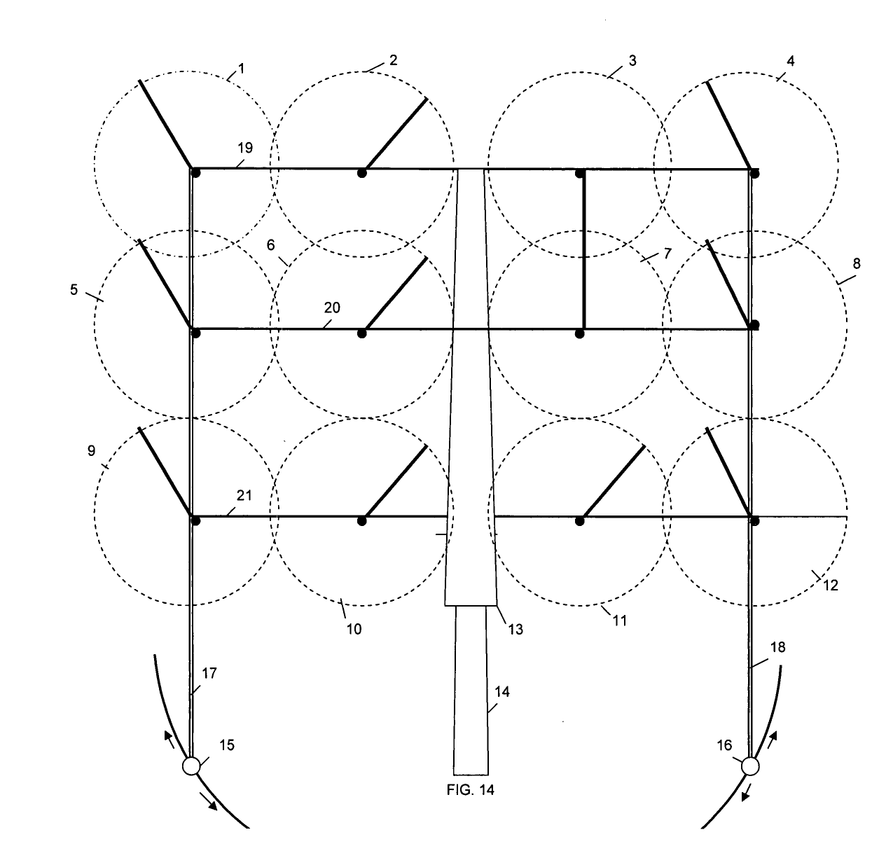

FIG. 14 illustrates some kinematics of multi-turbine wind farms. Where: wind turbines 1-12 made of one- and two-blade each; static compressors 13; vertical support arms 17, 18; train wheels 15, 16; and tower 8. The inventor Hermann Honnef proposed the multi-rotor concepts in 1930s. The difference between the well known multi-rotor concepts and present ones is that the present concept utilizes all swept areas around and in front of the tower by farms of wind turbines and static compressors. Furthermore, the present method of power extraction from the static and dynamic wind permits to reduce the distance between wind turbines. The distance depends on the mean wind speed of the site. The multi-rotor power plant with reduced distance between its wind turbines operates with synchronization of rotation of wind turbines blades. For the system that which works without synchronization, the worst case scenario is demonstrated by blades 3 and 7. As shown in this figure, blade 7 covers blade 3 from the wind, and blades 3 and 7 operate under stresses, such as operation of current wind turbines behind the tower. Since the wind is turbulent, it can make stresses to wind turbines, i.e. the wind can bend wind blades and reduce wind turbine's rotational speed.

In the present embodiment the static compressors 6 utilize the vested wind energy in front of the tower. These static compressors compress the surrounding air, which is then passes to the multistage compressors (not shown). The surrounding air is compressed by the pressure generated when the wind flows from large area input 6 into low area output 7 see FIG. 13. The present hybrid wind power plant produces electrical energy, heat energy, and the compressed air simultaneously. The supported horizontal arms 19-21 can be made from steel pipes or other materials and can be used as hot air transmission lines (when insulated) and as air heat energy exchangers (when the compressed air is cooled by the surrounding air).

The present hybrid thermodynamic cycle also permits to reduce the nacelle's and tower's weights by only installing the yaw mechanism and the wind turbine on the top of the tower, by installing farms of wind turbines on several levels of the tower, and by fastening compressors to the tower or the ground.

The present farms of one- and two-blade wind turbines operate under kinetic and mechanical stresses, which are produced by the always fluctuated wind. Furthermore, the present wind turbine's rotation is very uneven because of different wind speeds on the top and bottom levels of the tower. The present method of increasing swept area by installing wind turbine farms on the tower allows increasing rotational speed of all blades, which, in turn, allows decreasing the perturbed air made by the adjacent blades. Furthermore, the present embodiment permits the wind power plant to collect kinetic wind energy from the total swept area, and to convert its kinetic energy into mechanical energy in the phase of distributing its mechanical energy among the 12 shafts of the present wind turbines.

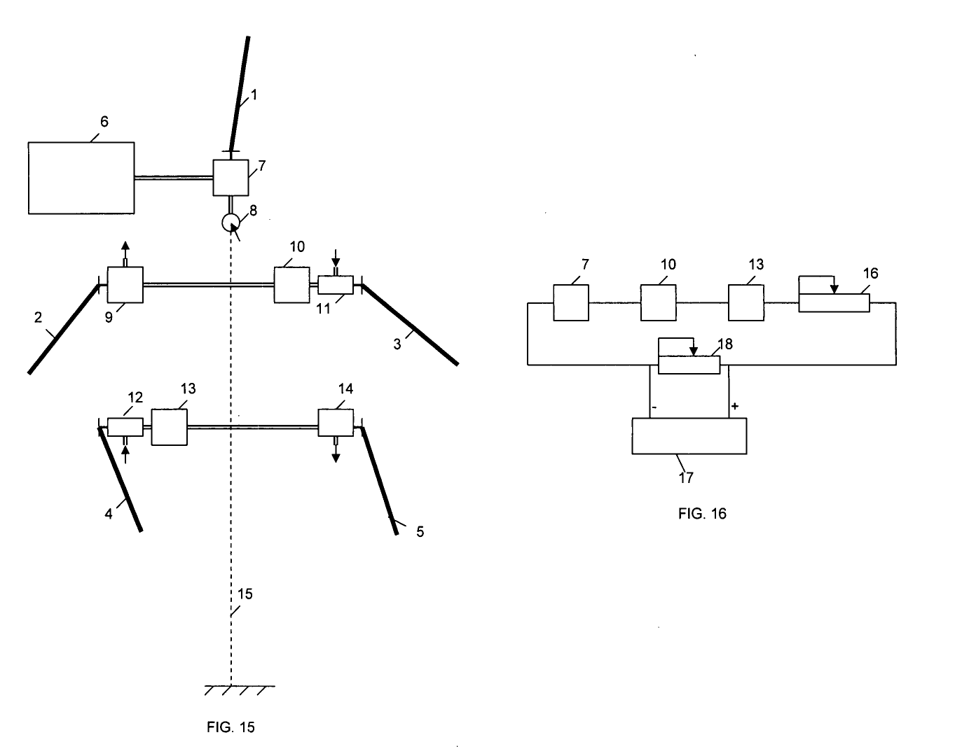

FIG. 15 illustrates the operation of the wind power plant. In this drawing, the wind power plant operates as a producer of an electrical energy and of compressed air. The compressed air is stored in the air storage 6. As the electrical energy producer, the compressors 11 and 12 compress air and pass it into the gas turbines inlet, then compressors 9 and 14 suck the exhaust air from the gas turbines. The gas turbine-generator system 10 and 13 produce electrical energy. Its thermodynamic process is illustrated in FIG. 3. The static compressor 8 and multistage compressors-gas turbine-generator system 7 produce electrical energy and the compressed air.

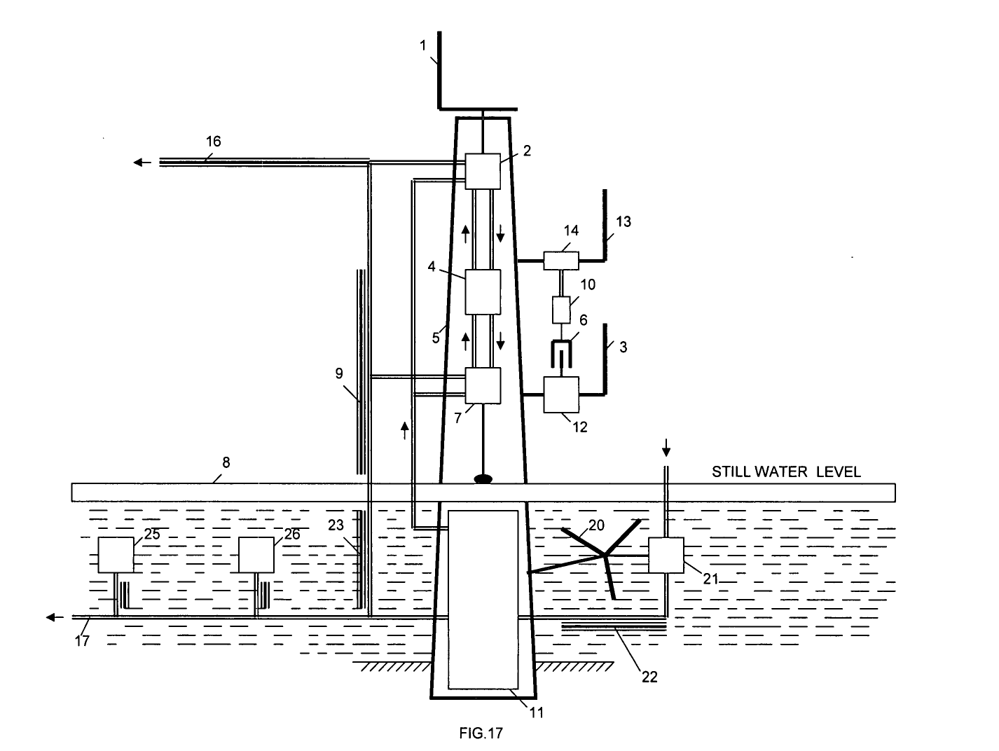

FIG. 16 illustrates a process of utilizing electrical energy. In this figure: generators 7, 10, 13; resistors 16, 18; DC/AC converter 17. The three generators 7, 10, 13 are connected in series. This connection permits to produce electricity at lower wind speed and two increase voltage threefold. Furthermore, this embodiment permits to increase efficiency of the power plant and to reduce weight and cost of generators. The resistors 16 and 18, which are located in the thermal storage area, consume extra electrical energy, convert it into heat energy, and allow energy produced by the wind power plant to be independent from the customer's loads. The resistors 18 is on when electrical energy consumption is low. The resistors 16 consume extra electrical energy produced by generators at high wind speed. The computer regulates and keeps constant voltage that is sent to the D/A converter 17. FIG. 17 illustrates an offshore wind-wave-tide hybrid power plant. In this embodiment, the offshore hybrid power plant includes: wind turbines 1, 3 and 13; hydraulic turbines 20; gas turbines-generator system 4; compressors 2, 7 and 21; wave floats 8; tower 5; tidal and wave turbines-air compressors power plants 25 and 26; air heat energy exchanger 9; water heat energy exchanger 22 and 23; generator 6; mechanical direction converter 14; gearboxes 10 and 12; air storage 11; heat energy line 16; and air line 17. In the present embodiment, compressors 2 and 7 work as producers of heat energy (adiabatic compression) and as producers of the compressed air (polytropic compression). Compressors 21, 25, and 26 operate as producers of the compressed air. The compressors 2, 7, 21, 25, and 26 are multistage compressors. The heat energy in the phase of hot compressed air and standardized compressed air passes to the customers through lines 16 and 17. The basic operation of the present wind-wave-tidal hybrid power plant is: wind kinetic energy is converted into mechanical energy in the phase of low speed rotating shaft of the wind turbine 1. Then, its mechanical energy is converted into the linear motion in the phase of low moving up/down pistons of the compressor 2 through connecting rods. Then, the compressor 2 converts this linear motion into heat energy, which then passes into the gas turbines-generator 4 and/or into the air line 16. Then, the gas turbines-generator converts this heat energy into electrical energy in the phase of clockwise and counterclockwise high speed rotating gas turbines-generator shafts. Then, the compressor 2 sucks the exhaust air during the vacuum-stroke and pushes it into the air and water heat energy exchangers 9 and 23 during the compression-stroke. Then, the compressed exhaust air is cooled in the air and water heat energy exchangers 9 and 23 and is passed into the air storage 11. The low oscillating wave kinetic energy is converted into mechanical energy from the phase of rising and falling floats 8 to the phase of rotating shaft of the compressor 7 in one direction. The compressor 7 converts wave energy into heat energy in the phase of hot compressed air. Then, this heat energy passes into the gas turbines-generator 4. Then the gas turbines-generator 4 converts this heat energy into the electrical energy. Then the compressor 7 sucks (vacuum-stroke) the exhaust air and pushes (compression stroke) it into the air and water heat energy exchangers 9 and 16. In the present embodiment, the gas turbines are fed by the wind and wave of the ocean kinetic energies. It permits the hybrid power plant to utilize wind and wave kinetic energies simultaneously. In the present embodiment, the wind turbines 3 and 13 convert wind energy into electrical energy through the mechanical direction converter 14 and through the gearboxes 10 and 12, which are coupled to the magnetic field and armature of the generator 6. The wind turbines 3 and 13 rotate clockwise and counterclockwise in the magnetic field and armature of the generator 6. This kinematical scheme permits wind turbines to effectively convert the wind energy into the electrical energy. The tidal kinetic motion is converted into the low speed rotational mechanical energy by the tidal (hydraulic) turbine 20. Then, the mechanical energy is converted into the compressed air through the compressor 21 and water heat energy exchanger 22, and the compressed air is passed into the air storage 11 or is directly transmitted to the land via the air line 17. The tidal-wave turbine-compressor systems 25 and 26 also produce compressed air in the same mechanism as outlined above. The tidal turbines are fastened to the foundation of the tower 5 through arms. The present compressors can even be made from plastics materials because of the low speed operation of the compressor, and because air is compressed polytropically, and so that the compressor bodies can be cooled by water. The benefit of utilizing wind-wave-tide kinetic energies simultaneously is the reduction of the hybrid power plant overall cost because the system uses the foundation of the tower, because it uses an electrical cable inside the air transmission lines, and increasing the operation time of the system. Furthermore, the cost is reduced because the tidal-wave-compressors systems 25 and 26 are installed alone the same air line. Furthermore, the benefit of the wind-wave-tide kinetic energy conversion systems is that it can be easily integrated with the solar system and with the thermal and air storages, which are all located on the land. The operating time of the integrated energy conversion systems is about 100%.

The present hybrid thermodynamic cycle permits the float systems to collect and convert the low oscillating wave kinetic energy of the ocean into the mechanical energy in the phase of low speed rotating compressors' shafts. The waves lift the floats and thus convert wave energy into mechanical energy, and then gravity lowers the floats back. The compressors convert this mechanical energy into heat energy. Then, the gas turbine converts heat energy into mechanical energy in the phase of high spinning shafts of the gas turbine. The generator, which is coupled to the gas turbine shaft, converts the mechanical energy into the electrical energy. This process is illustrated below.

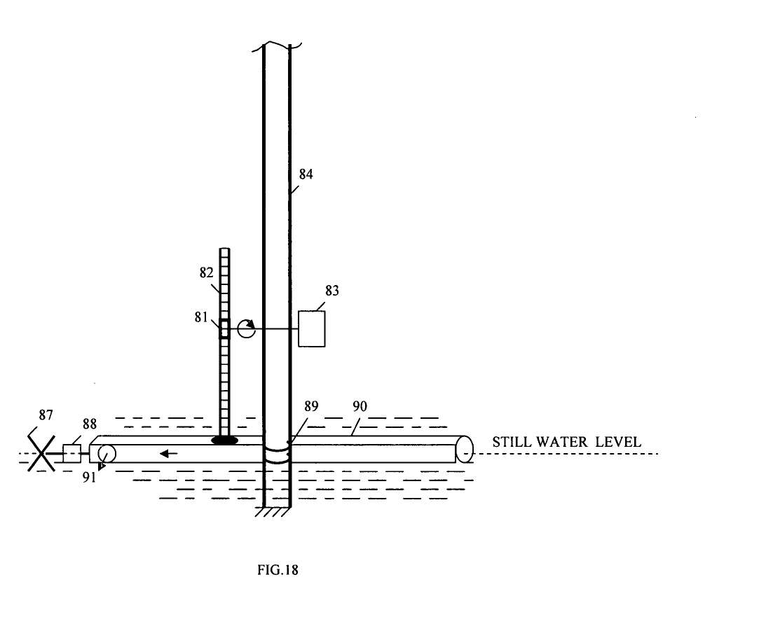

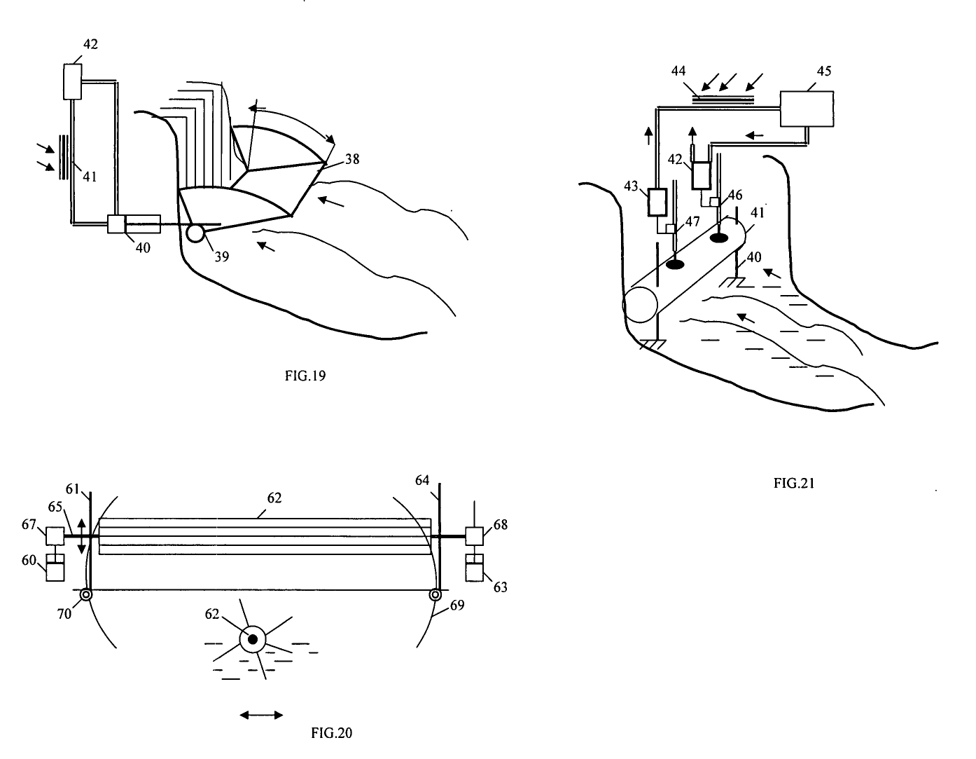

FIG. 18 illustrates the operation of the wave conversion system. This system includes air compressor 83; tower 84; float 90; water propeller 87; motor 88; rack 82; driving wheel 81; support ring 89. The operation of the wave energy conversion system is as follows: The float 90 is pushed up/down by the raising/falling waves and gravitational forces. This force and back motion converts the low oscillating wave kinetic energy into the mechanical energy in the phase of moving rack 82 up and down. Then, the mechanical energy is converted into the rotational motion in the phase of low speed rotation of the shaft of the compressor 83 in one direction through the driving wheel 81. Then, the compressor 83 converts the mechanical energy into the heat energy in the phase of the hot compressed air. The length of the rack 82 should compensate the wave and tide heights. The efficiency of the conversion of the wave kinetic energy into the mechanical energy is dependent on the direction of the waves and the drifting of the floats. In the present embodiment, these directions are controlled by the stabilizer system. The stabilizer system includes the water propeller 87, motor 88, propulsive system 91, and support ring 89. The motor 88 rotates the water propeller 87. The water propeller and propulsive force adjusts the floats according to the direction of waves and of the drifting float by rotating the floats around the tower. A propulsive force is produced by the compressed air.

FIG. 19 illustrates the operation of the wave-solar power plant. In the present drawing the wave kinetic energy in the phase of swinging sheet 38 is converted into mechanical energy in the phase of rotating shafts of the compressor 40 in one direction by the mechanical direction switch device 39. The compressor 40 converts mechanical energy into heat energy. Then, the heat energy is converted into electrical energy by the gas turbine-generator 42. Then, the exhaust air from the gas turbine is returned back to the system. During sunny daytime, the heat energy produced by the wave compressor 40 is combined with the solar radiation energy in the solar heat energy exchanger 41, and then the combined heat energy is converted into electrical energy. During off peak hours, the compressor 40 produces the compressed air polytropically (not shown).

FIG. 20 illustrates the operation of the onshore wave turbine. In the present embodiment, the wave turbine 62 converts wave energy into mechanical energy in the phase of swinging or rotating shaft 65 of the wave turbine 62. Then, the mechanical energy is converted into linear motion in the phase of force and back motion of the piston of the compressors 60 and 63 through the mechanical direction switch devices 67 and 68. Then the compressors convert the linear motion into the heat energy. The supporters 61 and 64 permit the wave turbine to utilize wave energy by regulating the wave turbine height with accordance to variation of tide and wave heights. The wheels 70 and the railway 69 permit the onshore wave turbine to track the direction of the waves.

FIG. 21 illustrates the operation of the onshore hybrid wave-solar power plant. In the present embodiment, wave energy is converted into mechanical energy in the phase of the float 41 moving up/down. Then, the compressor 43 converts mechanical energy into heat energy in the phase of hot compressed air. Then, the heat energy passes into the solar energy exchanger 44. In the solar energy exchanger the hot compressed air is heated by the solar radiation. Then, the combined heat energy passes into the gas turbine-generator system 45. The gas turbine-generator converts the heat energy into the electrical energy. Then, the compressor 42 sucks the exhaust air. And finally, the exhaust air is pushed into the compressor 43. The present method of using compressors in the inlet and outlet of the gas turbines permits to reduce the inlet temperature of the gas turbine. The reduction of the working temperature in the heat engine permits the gas turbine blades and bodies of the compressors to be made of even the plastic materials. The benefit of making the gas turbine and compressors from plastic materials is increased work life of its devices. The plastic material can better protect the gas turbine and the body of the compressors from corrosion and, furthermore, the plastic material permits to reduce the cost of the hybrid energy conversion system.

The onshore/offshore stationary or mobile hybrid power plants integrate the wind, tide, wave of the ocean kinetic and solar radiation energies through the wind turbine-compressor, tide turbine-compressor, wave turbine-compressor, solar energy heat exchanger, and gas turbine-generator. One benefit of utilizing above energies is that the hybrid power plant produces electrical energy. Furthermore, another benefit is that the hybrid power plant produces the compressed air, oxygen, and heat energy in the phase of hot clean air. Furthermore, another benefit of the hybrid power plant is that the cost of the hybrid energy conversion system is less than the current hybrid wind, offshore, onshore, wave and solar power plants. The current offshore wind power plant costs more than two times the current onshore power plant. Some factors that increase the cost of the current offshore power plants are the need to build foundation under water, to make special electrical cables for transmission of electricity under water, and to assemble a wind system using ships. The cost of the present hybrid wind-wave-tidal power plant will be reduced, for example, by using the same foundation by wave, tide, and wind turbines or by combining air transmitting lines with electrical cables in one unit. Furthermore, another benefit is that the onshore/offshore hybrid power plants are constructed from simple mechanical devices, such as wind, wave, and tide turbines, compressors, solar energy exchangers, gas turbines, and generators and by cheap and well known construction materials and technology.

### The Neighborhood Hybrid Power Plant

The present neighborhood hybrid power plant works as a primary energy producer. The features of the neighborhood hybrid power plant are explained in the following example. Assume: a customer consumes 1 kWh of electrical energy and 1.5 MJ of heat energy during 24 hours; solar radiation in the phase of heat energy is collected during 6 hours; the sun's radiation is about 1 kW per sq. meter; the working temperature in the heat energy exchanger is about 1400 K; the temperature in the thermal storage is about 1200 K; the temperature in the thermal storage while consuming heat energy is dropped from 1200 K to 800 K without adding a fuel heat to the system and is dropped from 800 K to 400 K while adding fuel heat to the system; the difference of the temperature in the heat energy exchanger and thermal storage is compensated by the temperature of fuel heat and flywheel kinetically energizing during the following 18 hours of operation of the system; thermal efficiency of the heat engine-generator is about 40%; the total thermal efficiency of the solar-heat engine-generator system is about 80% (customers utilize 30% of the unavoidable non-polluting hot exhaust air); heat energy and flywheel kinetic energy are lost in the system around 10% during first 6 hours and roughly 20% during the following 18 hours of operation of the system; and the system uses a working substance, such as a compressed air; the solar radiation in the phase of heat energy is partially converted into electricity, and partially collected in the thermal storage and in the flywheel during first 6 hours, and then, stored heat energy of the thermal storage and kinetic energy of the flywheel are converted into electricity and heat energy during the following 18 hours.

The neighborhood hybrid power plant converts total of heat energy into 1 kWh of electricity and of 1.5 MJ of non-polluting hot exhaust air during of 24 hours is about 256 MJ=(1*3.6:0.4*6+1*3.6:0.4:0.8*18). In the hybrid power plant which is used as working substance of the compressed air. In this example the compressed air is produced polytrophically by renewable energy sources. Assume: total energy (kinetic renewable energy, solar heat, and fuel heat) is spent to produce 1 kW of electricity and 1.5 MJ heat energy is about 500 MJ. The present hybrid power plant feeds by 10% % (50 MJ) of fossil fuel heat energy and 90% of renewable energy during sunny days and by 50% of fossil fuel heat energy and 50% of renewable energy during cloudy days. The fossil fuel heat energy is needed to produce 1 kWh of electricity and 1.5 MJ of heat energy during 24 hours by a current power plant of about 408 MJ=(1*3.6+1.5):0.3*24 or by a power plant and a fuel home heater or by a cogeneration power plant of about 330 MJ=1*3.6:0.3*24+1.5:0.85*24 Where: the total efficiency of an electrical system is about 30% and of a fuel heater is about 85%, and heat energy lost in the heater transmission line is about 15%.

Benefits of the present neighborhood hybrid power plant are: utilization of surrounding air as an intermediate working substance; air grid may transmit a compressed air, which is compressed polytrophically (closed to isothermal) or adiabatically by renewable energy; expansion its compressed air adiabatically and by adding solar and fuel heat energies; reduction of fossil fuel consumption; increasing of hybrid energy system efficiency up to 80-90%; transforming energy conversion system from supplemental to primary energy producer.

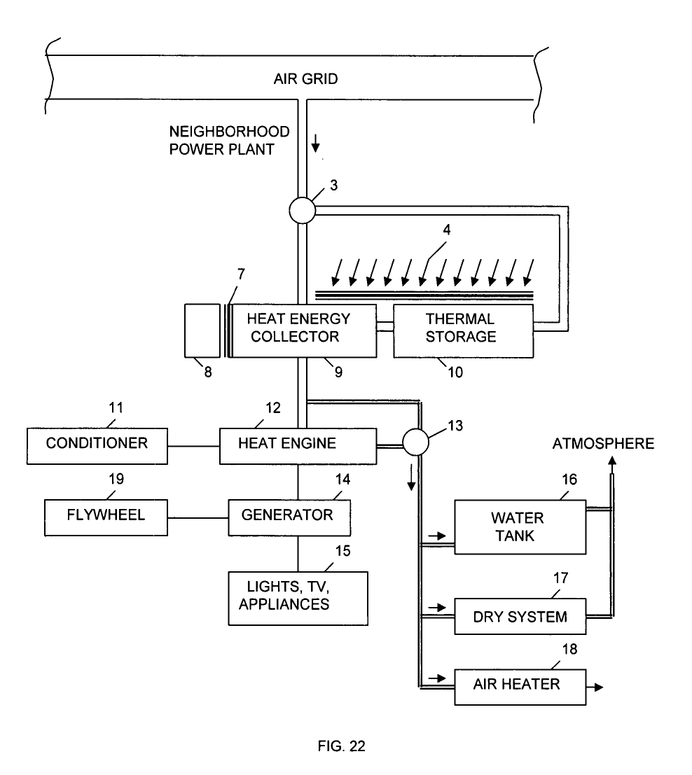

FIG. 22 schematically illustrates the basic operation of the neighborhood hybrid power plant. The neighborhood hybrid power plant includes: heat energy exchanger 7; heat energy collector 9; solar radiation energy exchanger 4; thermal storage 10; gas heater 8; heat engine 12; generator 14; flywheel 19; conditioner 11; valves 3 and 13. Customers' appliances and equipment: water tank 16; dry system 17; air heater 18; lights, TV, home appliances 15. The basic operation of the present neighborhood hybrid power plant is as follows. During sunny daytime, the compressed air from the air line or an air tank (not shown, used as a buffer between the air line and the heat energy collector for cost reduction of the compressed air consumed during peak hours) is passed through the open valve 3 in the heat energy collector 9. In the heat energy collector 9 the compressed air is heated by the solar radiation 4. This heat energy is then passed into the heat engine 12. The heat engine 12 converts the heat energy into the mechanical energy, and then electrical generator 14 converts mechanical energy into electrical energy. The electrical energy powers lights, TV, and home appliances 15. The non-polluting exhaust heat energy from the heat engine 12 and/or from the heat energy collector 9 is utilized by customers in the phase of warming water, clothes and air in the water tank 16, dry system 17, and air heater system 18, respectively. Direction of passing heat energy from the heat energy collector 9 and/or the heat engine 12 depends on the heat energy consumed by devices 16-18 and is regulated by the valve 13. The exhausted heat energy from the water tank and dry system is passed into the atmosphere. The mechanical or electrical energy is converted into kinetically energy in the phase of high spinning shaft of the flywheel 19. The mechanical energy can be converted into cold air by the conditioner 11. The present neighborhood power plant is a zero air pollution emission power plant during the sunny daytime. During nighttime or cloudy days, the heat energy collector 9 is heated by the heat energy stored in the thermal storage 10 or by the realized heat of combustion reaction in the gas heater 8. The benefit of the present embodiment of the neighborhood power plant is that the total thermal efficiency of the present neighborhood hybrid power plant is about 80-90% (customer utilizes both electrical energy and exhaust heat energy in the phase of hot low compressed clean air simultaneously) and the operating time of the energy conversion system is about 100%.

### The Thermal Module

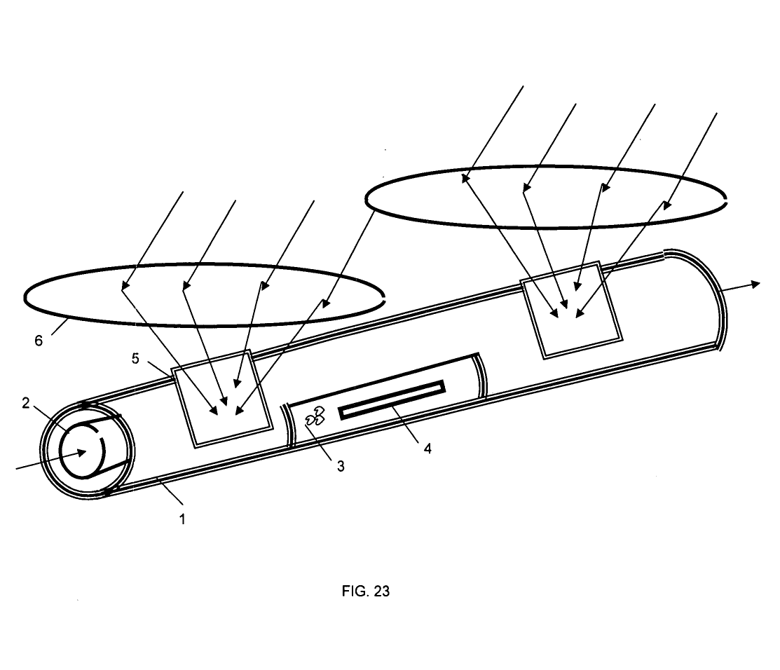

FIG. 23 schematically illustrates the basic operation of the thermal module. The present thermal module 1 includes: the heat energy collector 2, solar energy concentrators (lenses or mirrors) 6, thermal storage material, such as water or concrete (stone, rocks, sand) 3, heat insulation material, glasses 5, electrical resistors 4, and pneumatic system (not shown). The basic operation of the present thermal module is as follows: during sunny daytime the solar radiation (electromagnetic waves) is concentrated by the solar energy concentrators 6. Then, the concentrated solar radiation is passed to the surface of the heat energy collector 2 through glass 5 where it is converted into heat energy. The heat energy increases the temperature of the compressed air in the chamber of the heat energy collector. Also, the temperature of the thermal storage material 3 is increased through the surface of the heat energy collector. During nighttime or cloudy days, the collected thermal energy is returned back to the heat energy collector 2. The resistors 4 are used for converting extra electrical energy into heat energy, which is produced by the generator. The sun's motion is tracked by the pneumatic and computer controlling systems (not shown). The time of transferring heat energy is dependent on material of the bodies of the heat energy collector, on the thermal storage property, and on its temperature. The resistors are made as thin plates. According to the Stefan-Boltzmann Law the heat current rate of radiation is proportional to the surface area (including both sides), to the fourth power of the absolute temperature, and depends on the nature of the surface. In the present thermal storage, the chosen thermal storage material is a concrete (stone, rocks, sand). These materials have good product of density and specific heat capacity. Furthermore, its material permits the thermal storage to collect thermal energy with high temperature and low pressure. The hybrid energy system is combined array of the thermal modules in parallel and/or in series. One benefit of making thermal modules is that the solar radiation, the compressed air and stored thermal energies are close to each other. This proximity permits the present heat energy collectors and thermal storages to effectively transfer heat by mechanisms of conduction, convection, and radiation. Furthermore, another benefit of making thermal modules is that it is easy to attach a heat insulation substance (even vacuum) to the module. Furthermore, other benefits of making the thermal modules are reduction of flow resistance, heat insulation, piping expenses, and cost of assembling. Furthermore, another benefit of making the thermal modules is the convenience in transporting modules. Yet another benefit of making the thermal modules is that the solar radiation collector, which is efficient and simple in construction, would be a notable advance in the field of energy production.

### The Compressor

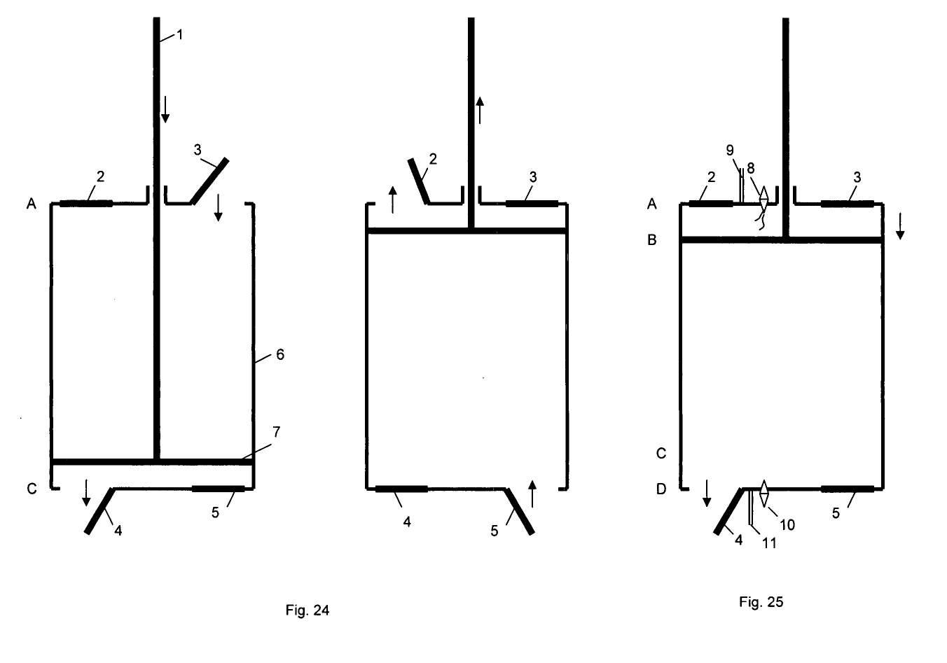

FIG. 24 schematically illustrates the basic operation of the compressor. The compressor is comprised of input valves 3 and 5, exhaust valves 2 and 4, piston 7, cylinder 6, connecting rod 1, fuel lines 9 and 11, and spark plugs 8 and 10. The external mechanical energy pushes/pulls the piston 7. It permits the external mechanical energy to be converted into heat energy in the phase of hot compressed air. The basic operation of the present thermodynamic cycle is as follows: 1. during the first compression stroke external mechanical energy moves the piston 7 down. The piston 7 pushes out the compressed air through the exhaust valve 4. At the same time, when the piston 7 is moved down, the new portion of air flows into the cylinder 6 through the open intake valve 3 (intake-stroke). At the lowest position of the piston 7, valves 3 and 4 are closed. 2. During the second compression stroke, when piston 7 moves up, the intake 5 and exhaust valves 2 are opened. The air is pushed out through the open valve 2 and the new portion of air flows into the cylinder 6 through open intake valve 5. At the upper position of the piston 7 the valves 2 and 5 are closed and the compressor is ready for the next cycle. In the present embodiment two compression-strokes represent one thermodynamic cycle.

In addition to working as air compressors, the present compressors can be used as heat engine, as illustrated in FIG. 25.

FIG. 25 schematically illustrates the basic operation of the compressor as a heat engine. The heat engine is operated as Otto and Diesel engine. Thermodynamic cycle of the heat engine is as follows: 1. during the intake-stroke (piston 7 moves down from position A to position B) the compressed air is passed into the cylinder 6 through the open valve 3 and a small portion of fuel is passed through the fuel line 9. At the position B the valve 3 is closed and the mixture is ignited by the spark plug 8. The realized heat of combustion reaction expands and does work by moving down the piston 7 (power-stroke). During expansion the temperature is dropped, then the new small portion of fuel is injected into the cylinder, and then new portion of fuel and the remaining air is combusted. The temperature in the cylinder increases. By continuously injecting small portion of fuel into the cylinder, the heat engine completely converts the realized heat of combustion reaction into mechanical energy with maximum permitted pressure. The amount of oxygen in the mixture is supposed to be enough to complete the combustion reaction during the power-stroke. The exhaust products are pushed out through the open valve 4 (exhaust-stroke). At the end of the exhaust-stroke (position D) the valve 4 is closed.

2. During the intake-stroke (piston 7 moves up from position D to position C) the compressed air is passed into the cylinder 6 through the open valve 5 and a small portion of the fuel is passed through the fuel line 11. The heat engine is ready for next power-stroke. In the present embodiment one thermodynamic cycle is represented by two power-strokes.

The compressors operate without oil lubrication because of low speed of rotation of the moving parts of compressors and because bodies of compressors are cooled by the wind or by river and sea water. The compression ratio is regulated by varying air mass in the cylinder. The sequence of opening valves and the direction of passing gasses are dependent on the adiabatically or polytropically compressing gasses. The low speed of moving compressors pistons permits the computer to regulate a sequence of opening valves. Below are some examples that illustrate some of the possibilities of the present compressors.

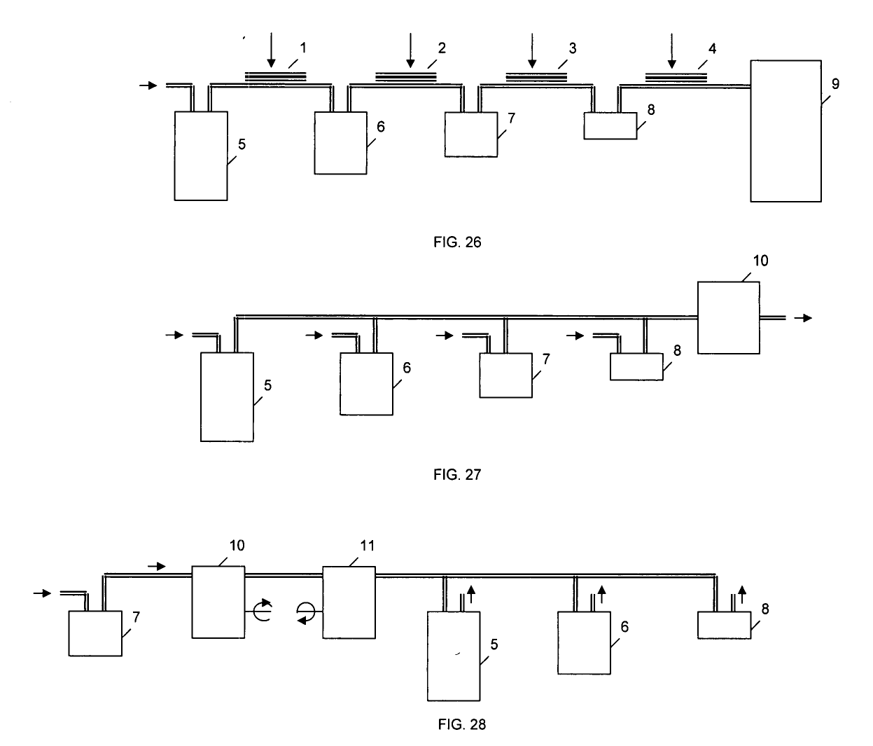

FIG. 26 schematically illustrates polytrophic compression process. In the present application, air is compressed and passed into the air storage 9 by connecting the compressors 5-8 and the air heat energy exchangers 1-4 in series. The total compression ratio of four compressors is a multiplication of compression ratio of each cylinder.

FIG. 27 schematically illustrates adiabatic compression process. In this application, air is compressed and is then passed into the heat engine 10 by connecting the compressors 5-8 in parallel.

FIG. 28 schematically illustrates application of the hybrid heat engine. In this application the compressor 7 compresses air, which is then passed into gas turbines 10 and 11. Gas turbines rotate clockwise and counterclockwise. The unavoidable exhaust air is sucked out by connecting three compressors 5, 6 and 8 in parallel.

### The Method of Utilizing Electrical Energy

Some of the most important features of the current direct conversion of kinetic energy into electrical energy are the stability of the system and the ability to keep frequency or other parameters constant. To maintain the above features, for example, in the wind power plant the following methods and components are used: an aerodynamic pitch regulator, a control system, electronic regulators, and disk brakes. This equipment reduces stresses made by oscillating and vibrating kinetic and mechanical energies, such as gusts or gearboxes, or when the upper blade is bent backwards as a result of maximum wind power and the lower blade is passed behind the tower. The present method of instantaneous extraction of renewable energy includes steps of utilizing all produced electrical energy during on/off peak hours. It is possible to catch all of the produced electrical energy by adding storages to the energy conversion system, such as thermal and air. The device, which permits to convert extra electrical energy into heat energy, is an analog regulator. The analog regulator includes resistors and an electronic control system. The resistors of the analog regulator are connected to the generator in parallel and in series. It permits the generator to sense any kinetic and mechanical energy changes. Furthermore, the present hybrid thermodynamic cycle permits the present turbine-compressors-heat engine-generator system to eliminate any kinetic and mechanical stresses and instability created by the renewable energy sources and energy conversion devices. The present generator follows the three conditions of the Faraday's law: a conductor, a magnetic field, and motion of the conductor in the magnetic field.

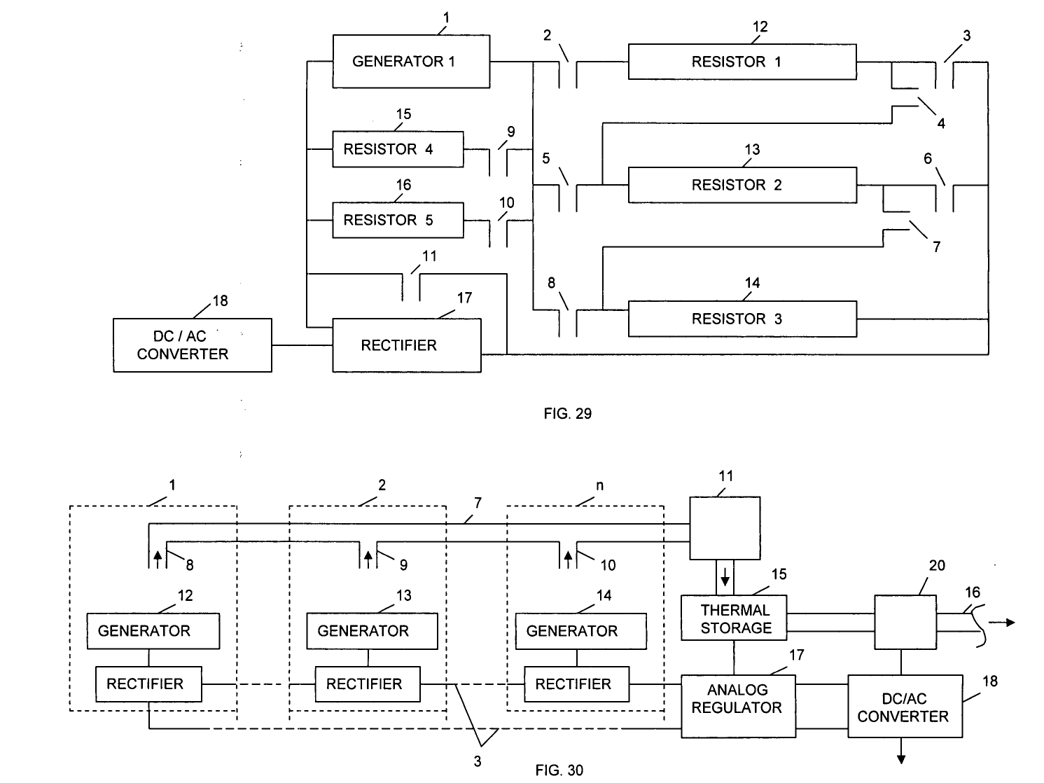

FIG. 29 schematically illustrates the present method of utilizing electrical energy. The present generator system includes generator 1, DC/AC converter 18, rectifier 17, resistors 12-16, and mechanical or static switches (transistors, thyristors) 2-11. The generator 1 converts mechanical energy into electrical energy, then the electrical energy is passed to the DC/AC converter 18 through the resistors 12-16 connected in series/parallel and rectifier 17. In the present embodiment, the input voltage to the DC/AC converter 18 is roughly a constant parameter. The input voltage to DC/AC converter 18 is regulated by the analog regulator. The analog regulator permits the hybrid energy systems, such as solar-wind-water-tide-wave hybrid systems, to maximum utilize its energies by converting electrical energy into heat energy and then collecting its heat energy in the thermal storages through the resistors 1-5. The present method of utilizing extra electrical energy permits, for example, offshore hybrid power plants to transmit all electrical energy and then on the land to convert this electrical energy into standard form of electricity and the remaining electrical energy into heat energy.

FIG. 30 illustrates the process of utilizing extra electrical energy. In the present embodiment, the electrical systems 1-n mean the farms of the hybrid electrical power plants. The generators 12-14 produce electrical energy, and then rectifiers convert this electrical energy from AC to DC. The electrical sources are connected in series and the electrical energy is transmitted to the DC/AC converter through the analog regulator 17, which is located on land, via cable 3. On the land, the normalized electrical energy is either connected to the electrical grid or transmitted to the local customers. During times of low electrical consumption or maximum kinetic energy production, the analog regulator 17 permits extra electrical energy to be converted into heat energy and the heat energy to be stored in the thermal storage 15. During peak hours and times of low renewable kinetic energy availability or at night, the compressed air is taken from the air storage 11 and is heated by the heat energy taken from the thermal storage. Then the turbine-generator 20 converts heat energy into electrical energy and passes electrical energy to the DC/AC converter 18. The clean exhaust heat air is passed to the customers through the air transmitting line 16. The benefit of this embodiment is a high thermal efficiency of conversion of kinetic energy into electrical energy by the farms of the hybrid power plants and cost reduction of air and electricity transmission. Disadvantage of this embodiment is that if the cable is broken, the whole electrical transmission line cannot function.

### The Hybrid Heat Engine

The present hybrid thermodynamic cycle method permits the present hybrid heat engine to increase thermal efficiency by splitting the compression, power, and exhaust strokes. Furthermore, the compression and exhaust strokes are powered by the solar thermodynamic cycle, such as kinetic energies of wind, water of river, and tide-wave of the ocean. In the present invention, the compression-stroke belongs to the process of making the compressed air/oxygen and conversion of renewable kinetic energies into heat energy in the phase of hot compressed air. Then the hot compressed air is converted into mechanical energy by the heat engine. Preparation of the compressed air outside of the heat engine permits the heat engine to:

Eliminate a compression-stroke;

Reduce time of an intake-stroke;

Transform a four-stroke thermodynamic cycle into a three-stroke thermodynamic cycle;

Combine a piston and a gas turbine heat engines into hybrid heat engine;

Reduce fossil fuel consumption;

Operate a hybrid heat engine in the highly efficient state;

Increase thermal efficiency of a heat engine by increasing the compression ratio of the fuel and air mixture in the combustion chamber without paying penalty of the mixture exploding spontaneously;

Reduce all heat energy losses in a heat engine;

Reduce weight of a heat engine;

Eliminate a pollutant, such as nitrous oxides-NOX by keeping a combustion reaction temperature less than 1573 K;

Permit a present heat engine to work in on/off mode of operation. The proposed heat engine, such as three cylinders internal combustion engine, has no “Dead point”. The on/off mode of operation of the heat engine will be beneficial to the vehicles (17% of the heat energy contents in the fuel are lost on idling, such as at stoplight and starting engine);

Permit a power plant to reduce losses on a power train (10% of heat energy contents in the fuel) by reducing the number of steps in the gear box or even eliminating a gear box completely.

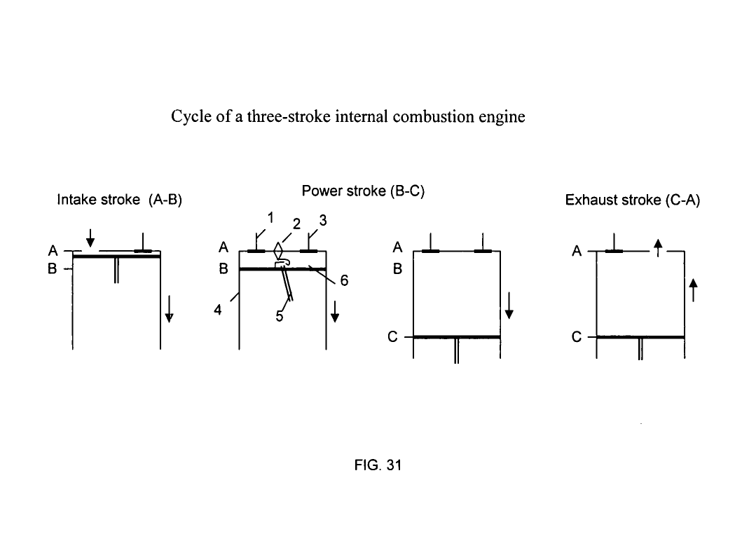

FIG. 31 illustrates thermodynamic three-stroke cycle of an internal combustion engine. Where: 1 is an intake valve; 2—spark plug firing; 3—exhaust valve; 4—cylinder; 6—piston; 5—connecting rods.

Thermodynamic three-stroke cycle of an internal combustion engine includes:

1. Intake-stroke. The piston 6 moves down from position A to position B. The already prepared compressed fuel and air mixture passes through the open intake valve 1 into the cylinder.

2. Power-stroke. At the position B the intake valve 1 is closed, and the spark plug 2 ignites the mixture. The mixture combusts and the realized heat of combustion reaction converts into mechanical energy in the phase of moving the piston 6 down from position B to position C.

3. Exhaust stroke. At the position C the piston moves up and pushes the exhaust gasses out through the open valve 3. At the position A the exhaust valve is closed and the internal combustion engine is ready for the next thermodynamic cycle.

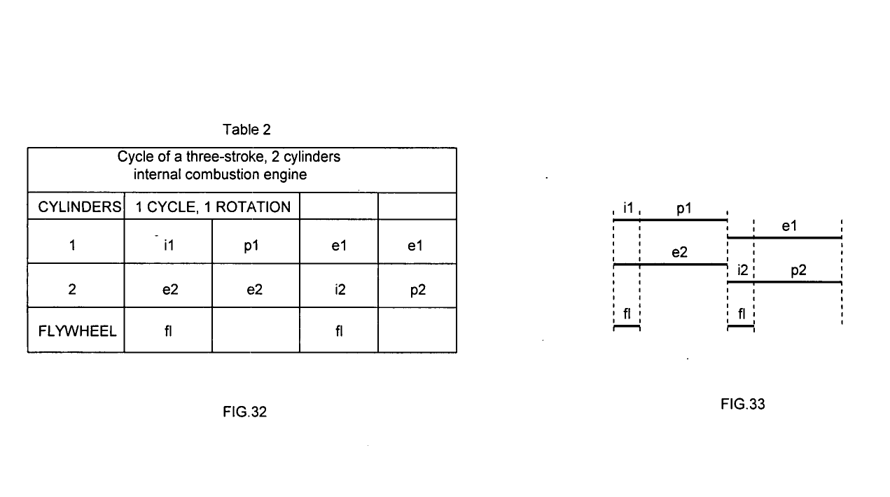

FIG. 32-33 illustrates the sequence of operation of the three-stroke cycle of the 2 cylinders internal combustion engine. In these illustrations i1, i2, p1, p2, e1, e2 mean intake, power, and exhaust-strokes in the cylinders 1, 2 respectively, and fl means the flywheel. Assume the present thermodynamic cycle starts from power-stroke in the cylinder 1. During the power-stroke in the cylinder 1 the compressed mixture is ignited and the realized heat of combustion reaction is converted into mechanical energy in the phase of pushing the piston of the cylinder 1 down. The moving piston rotates the crankshaft. The mechanical energy of the crankshaft moves the piston of the cylinder 2 up. The piston pushes the exhaust gasses out from the cylinder 2. During the power-stroke in the cylinder 2, the compressed mixture is ignited and the realized heat of combustion reaction is converted into mechanical energy in the phase of pushing the piston of the cylinder 2 down. The moving piston rotates the crankshaft. The mechanical energy of the crankshaft moves the piston of the cylinder 1 up and the piston pushes the exhaust gasses out from the cylinder 1. In the present internal combustion engine, the power-strokes p1 and p2 compose less than half of 1 rotation of the thermodynamic cycle, see FIG. 33. It means that the present three-stroke cycle 2-cylinders internal combustion engine needs a flywheel for compensating for kinetic energy needed to flow the mixture into the cylinder and push the exhaust products out from the cylinder. The flywheel is charged during the power-strokes (p1, p2) and discharged during the input (i1, i2) and exhaust (e1, e2) strokes. The thermal efficiency of the present heat engine is reduced by several factors, such as friction, pumping of oil and water, and loss of heat energy through the wall.

The present three-stroke thermodynamic cycle permits the internal combustion engine to convert heat energy into mechanical energy with maximum torque. In the present internal combustion engine the compression-stroke is eliminated and the intake-stroke is reduced. It means that a four-stroke thermodynamic cycle is transformed into a three-stroke thermodynamic cycle. Furthermore, the current four-stroke thermodynamic cycle, which is served by two crankshaft rotations, will now be served by one crankshaft rotation of the internal combustion engine. Increasing the compression ratio of the fuel and air mixture should increase the thermal efficiency of the present internal combustion engine. External compressor prepares the compressed mixture of the fuel and air. Furthermore, the compression ratio of the mixture of the fuel and air is increased without paying penalty of spontaneously exploding the mixture. The limitation of using the higher compression ratio in the present internal combustion engine is a mechanical strength of, for example, connecting rods, rings, the crankshaft, or the combustion chamber itself and temperature. Furthermore, the thermal efficiency of the present internal combustion engine is increased by eliminating heat energy lost through the wall during the input and compression strokes. Additionally, the thermal efficiency of the present internal combustion engine is increased by eliminating friction and pumping heat energy lost during the intake and compression strokes. Furthermore, the thermal efficiency of the present internal combustion engine is increased by keeping the volumetric efficiency (Ve) of about 100%. The Ve of the present heat engine is independent from load, dynamic features of operations, temperature of the cylinders' walls and speed of crankshaft rotation. Moreover, the thermal efficiency of the present internal combustion engine is increased by preparing the compressed air/oxygen or combustion mixture in advance. Furthermore, the thermal efficiency of the present internal combustion engine is increased by involving the renewable kinetic energy sources in the compressing processes. Additionally, the thermal efficiency of the present internal combustion engine is increased by involving the renewable kinetic energy sources in the exhausting process. Involving the renewable kinetic energy sources in the compressing and exhausting strokes means of transforming a three-stroke thermodynamic cycle into a two-stroke thermodynamic cycle, such as input and power strokes thermodynamic cycle. Moreover, the thermal efficiency of the present internal combustion engine is increased by increasing the temperature difference between the inlet and the outlet of the heat engine. The inlet temperature of the internal combustion engine depends on the combined temperature of compressed mixture and the realized heat of the combustion reaction. The outlet temperature of the internal combustion engine is lowered by pulling the exhaust products out by the external compressor. The outlet temperature of the piston internal combustion engine is lowered by the gas turbine, an air heat energy exchanger, and a compressor. The air heat energy exchanger is installed when the temperature of the exhaust gasses after vacuuming process is higher than the temperature of the surrounding air. In the present invention, the piston internal combustion engine can be integrated with gas turbine and compressors in hybrid heat engine. The advantage of making the hybrid heat engine is a maximum realization of the temperature of the combustion reaction. The advantage of the present hybrid thermodynamic cycle method is easy conversion of the current four-stroke cycle heat engine into the present three-stroke cycle heat engine. For this conversion it is necessary to change a rotational ratio between the crankshaft and a camshaft as well as to change the configuration of a camshaft. These changes permit the input and output valves' sequences to operate according to the present thermodynamic cycle. Another advantage of preparing the compressed air in advance and vacuuming the exhaust gasses by external kinetic renewable energies is reduction of the flywheel kinetic energy. Yet another advantage of preparing the compressed air in advance and vacuuming the exhaust gasses out by external kinetic renewable energies is that the three-stroke cycle heat engine can operate even with a single cylinder.

The thermal efficiency of the hybrid heat engine e=W/(Q+Wr). Where: W—combined useful mechanical energy of the crankshaft of the piston internal combustion engine and the shaft of the gas turbine heat engine; Q-heat energy in the fuel; Wr—renewable kinetic energies (spent for mixture compression and exhausting products of the combustion reaction).

The thermal efficiency of the hybrid heat engine is reduced by loosing heat energy through the walls of piston and gas turbine heat engines, external compressors, friction, and pumping oil in the hybrid heat engine.

The advantage of using oxygen with the temperature reduction substances, such as carbon dioxide and water, in the internal combustion engine of the conventional vehicle is elimination/reduction of air pollution (exhaust gasses contain only carbon dioxide with pollutants and water). Furthermore, process of eliminating/reducing air polluting emissions includes steps of cooling, separating exhaust products into the water and carbon dioxide with pollutant, collecting carbon dioxide in the compressed gasses or liquid phases, and disposing of exhaust gasses. Disposing of the carbon dioxide with pollutants in the disposal stations implies that the proposed vehicle is a zero pollutant heat engine.

Following example illustrates the operation of a hybrid heat engine in the hybrid drive system.

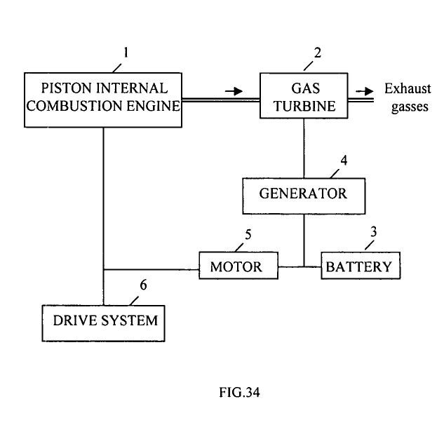

FIG. 34 schematically illustrates the operation of hybrid drive system. In the present embodiment: piston internal combustion engine 1; gas turbine 2; generator 4; motor/generator 5; battery 3; drive system 6. The piston internal combustion engine 1 converts the realized heat of combustion reaction into mechanical energy in the phase of the rotating crankshaft. The crankshaft of the piston internal combustion engine 1 is connected to the drive system 6 and motor/generator 5. The temperature of exhaust gasses from the internal combustion engine 1 is converted into mechanical energy by the gas turbine 2 and then into electrical energy by the generator 4. The generator 4 powers the motor 5 and charges the battery 3. The operation of the piston internal combustion and gas turbine heat engines' during on and idling modes of the vehicles is: The piston internal combustion engine 1 charges the battery 3 through the motor/generator 5. Also the gas turbine 2 converts the exhaust gasses from the piston internal combustion engine 1 into mechanical energy. Then the generator 4 converts the mechanical energy into electrical energy. And finally, the generator charges the battery 3. During the operation of the piston internal combustion engine in the on and braking modes of the vehicle, the kinetic energy of wheels charges the battery 3 through the motor/generator 5. During the operation of the piston internal combustion engine in the on and the accelerating modes of the vehicle, the piston internal combustion engine 1 and the battery 3 serve the drive system simultaneously. During the off mode of operation of the heat engine 1, only the battery 3 is needed to serve the drive system. The benefit of having the on/off mode of operation of the piston internal combustion engine 1 is to be able to store less electrical energy in the battery. This allows reducing the weight and ultimately the cost of the battery.

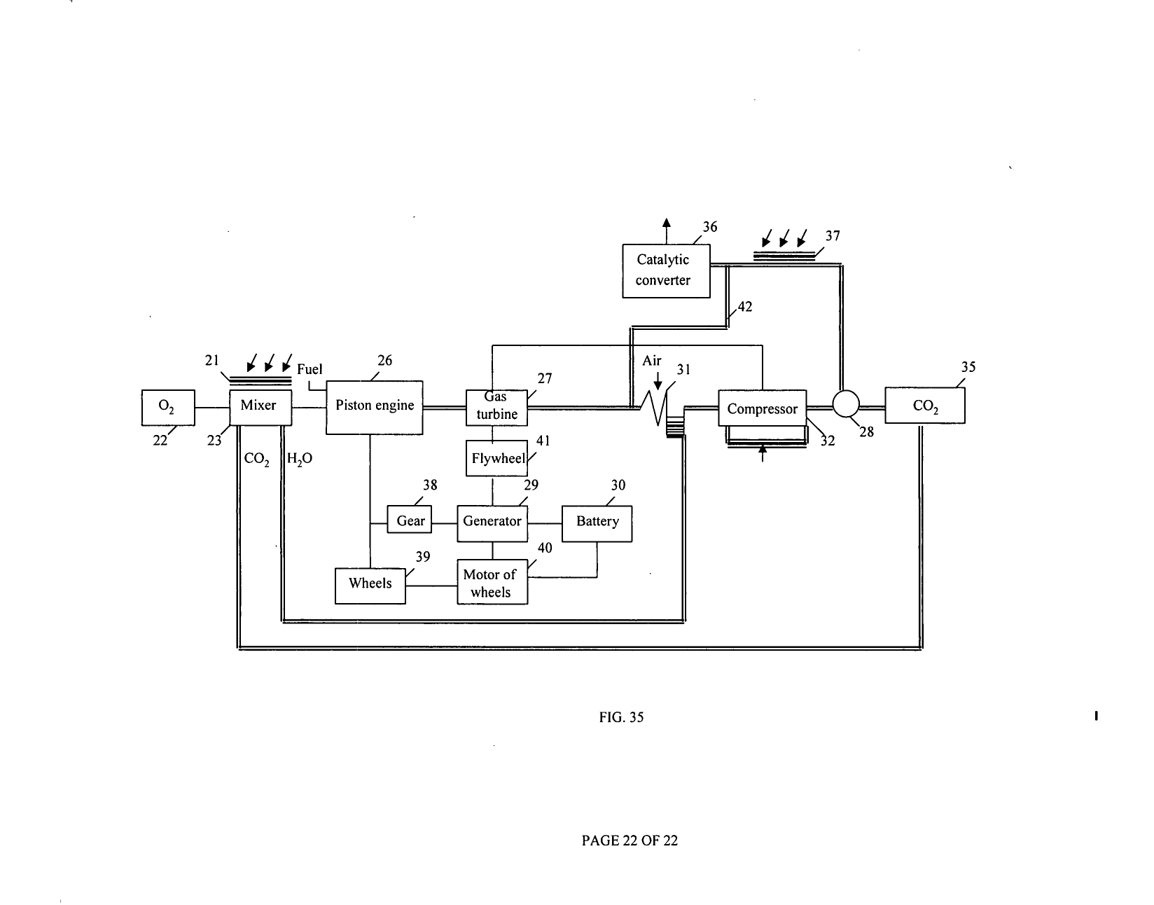

It is understood that exemplary of the hybrid power plant and hybrid heat engine based on the hybrid thermodynamic cycle described herein and shown in the figures represents only a presently preferred embodiment of the invention. Indeed, various modifications and additions may be made to such embodiment and may be implemented to adapt the present invention for use in variety of different applications. One example is illustrated in FIG. 35.

FIG. 35 schematically illustrates the present method of reduction/eliminating of air pollution emission. As mentioned above, the cold catalytic converter of the heat engines and a short trip of running of vehicles account for most of the air pollution emission in the city. The present method of collecting the carbon dioxide in the container or heating the carbon dioxide by solar radiation and than catalyzing it by a catalytic converter permits the present hybrid heat engine to reduce/eliminate air polluting emissions. Furthermore, the present kinematics' scheme permits the hybrid heat engines to additionally reduce air pollution emission by working engines in on/off modes of operation. In the present drive system drawn: piston combustion engine 26; gas turbine 27, flywheel 41, catalytic converter 36; air heat energy exchanger 31; multistage compressor 32; carbon dioxide container 35; oxygen container 22; mixer 23; generator 29; battery 30; gearbox 38, wheels 39, wheels motor 40, valve 28; solar heat energy exchangers 21, 37. The operation of the present hybrid heat engine is as follows: 1) the compressed mixture of the fuel and oxygen and temperature reduction working substances, such as water and carbon dioxide, are heated in the solar heat energy exchanger 21 by the solar radiation and then the heated compressed mixture passes to the piston heat engine 26. The mixture combusts and the realized heat of combustion reaction are converted into mechanical energy in the phase of rotating the crankshaft of the piston combustion engine. The crankshaft is coupled to wheels 39 and through the gearbox 38 to the rotating magnetic field of generator 29. The exhaust gasses pass into the gas turbine 27. The gas turbine 27 converts the exhaust gasses temperature into mechanical energy in the phase of rotating shaft of the gas turbine. The shaft of the gas turbine is coupled to the flywheel 41 and to the armature of the generator 29. The shafts of the field magnet and armature of the generator 29 rotate in opposite direction. The exhausted gasses with pollutants from the gas turbine pass into the air heat energy exchanger 31 cool by the temperature of the surrounding air, separate into water and carbon dioxide with pollutants, and then carbon dioxide with pollutants pass into the multistage compressor 32. The multistage compressor 32 is coupled to the gas turbine 27. The multistage compressor 32 compresses the carbon dioxide with pollutants and passes these gasses into the container 35. The carbon dioxide with pollutants from the container 35 is partially returned back to the combustion process as the temperature reducing substances. During sunny daytime, the carbon dioxide with pollutants from the container 35 or the compressor 32 passes into the solar heat energy exchanger 37. In the solar heat energy exchanger 37, the exhaust products are heated to the temperature of best performance of the catalytic converter and pass into the catalytic converter 36. Then carbon dioxide is passed to the surrounding air. The valve 28 regulates the direction of flow of carbon dioxide with pollutants to the solar catalytic converter. During night or cloudy day, carbon dioxide with pollutants flow through the pipeline 42 directly into the catalytic converter 36. The generator 29 charges the battery 30 and powers the wheels of motor 40. During the accelerating mode, the piston heat engine and the motor 40 rotate the wheels. The battery 30 and the generator 29 power the motor 40. The benefits of the present embodiment is that, in the idling mode, the heat engines can be decoupled from the wheels and can power the generator 29 through the gear box 38 and gas turbine 27. The generator 29 charges the battery 30. Another benefit of the present embodiment is that the kinetic energy of the flywheel keeps gas turbine rotating at high speed in the off mode of operation. Still another benefit of the present embodiment is that the gas turbine realizes most of the temperature of the exhaust gases. Disadvantage of the present embodiment is that vehicles need to keep fuel, oxygen, temperature reduction substances such as carbon dioxide and water, and containers on the board. For example, according to the stoichiometric burning of 20 kg of methane it is necessary to keep on board about 20 kg of fuel and 80 kg of oxygen. Temperature reduction substances, such as carbon dioxide and water, are made on board.

In the present embodiment, the solar thermodynamic cycle is used for preparing the compressed air, oxygen, the temperature reduction substances, and for catalyzing exhaust products. One advantage of integrating two thermodynamic cycles in the present embodiment is that hybrid heat engines reduce fossil fuel consumption and increase solar radiation consumption. Another advantage of integrating two thermodynamic cycles is that there are multiple other applications where hybrid heat engines can be useful, such as the mobile homes or trailers on wheels, or trucks, or trains. The difference between trucks, trailers, trains, and cars is only the space the solar energy collectors would occupy.

The above analysis of the present hybrid thermodynamic cycle method and hybrid energy systems based thereon demonstrate high efficiency of conversion of solar, water of river, tide and wave of ocean, and fuel energies into mechanical-electrical energies. Furthermore, currently there is no energy conversion system present, including a combustion engine, a hybrid electrical drive system, fuel cell, solar, tide, wave, and wind electrical power plants that are as efficient and as friendly to the environment as the present hybrid energy system.

What is claimed is:

1. A hybrid thermodynamic cycle as a method of integration, consisting of collection, operation, conversion, transmission, and storage of incompatible types of energy, such as fossil fuel, renewable solar radiation, kinetic wind, river water, and ocean tide and wave energies; utilization of surrounding air as an intermediate working substance; reduction of fossil fuel consumption; maximum utilization of renewable energy sources; increase of hybrid energy systems efficiency and operating time; transforming energy conversion systems from supplemental to primary energy producers.

2. A hybrid thermodynamic cycle of claim 1 is a two-phase method of converting renewable energy into mechanical/electrical energy. The first phase of converting renewable energy into mechanical/electrical energy includes: conversion of low oscillating renewable kinetic energy into heat energy; preparing and storing of a standardized (cooled) compressed air; collecting and storing of renewable solar radiation and kinetic energy in the form of heat energy. The second phase of converting renewable energy into mechanical/electrical energy includes: returning of stored a standardized compressed air and heat energy to a conversion system; conversion of heat energy into mechanical/electrical energy in the phase of high spinning heat engine-generator's shaft.

3. A hybrid energy system based on a hybrid thermodynamic cycle of claim 1 is comprised of solar-water, solar-wind, solar-tide, solar-wave, wind-wave-tide, wind-tide, wave-tide, wind-water, solar-wind-water, solar-wind-tide, solar-wind-wave, solar-wind-tide-wave, solar-fuel, water-fuel, wind-fuel, tide-fuel, wave-fuel, solar-water-fuel, solar-wind-fuel, solar-tide-fuel, solar-wave-fuel, wind-wave-tide-fuel, wind-tide-fuel, wind-water-fuel, solar-wind-water-fuel, solar-wind-tide-fuel, solar-wind-wave-fuel, and solar-wind-tide-wave-fuel hybrid power plants.

4. A hybrid energy system based on a hybrid thermodynamic cycle of claim 1 is comprised of farms of horizontal and vertical axis wind, sheet wave, tide turbines, rotor wave, float wave, and water turbines, multistage hybrid compressor systems, solar, air and water heat energy exchangers, air and thermal storages, hybrid heat engines, electrical conversion systems, air and electrical transmission lines.

5. A hybrid thermodynamic cycle of claim 1 is comprised of a three and two-stroke thermodynamic cycle of a piston internal combustion engine. A three-stroke thermodynamic cycle is comprised of eliminating a compression-stroke and reducing an intake-stroke. A two-stroke thermodynamic cycle is comprised of eliminating a compression-stroke, an exhaust-stroke, and reducing an intake-stroke.

6. A hybrid thermodynamic cycle of claim 1 is comprised of a two and one-stroke thermodynamic cycle of a linear free piston engine. A two-stroke thermodynamic cycle is comprised of eliminating a compression-stroke, an exhaust-stroke, and reducing an intake-stroke. A one power-stroke thermodynamic cycle is comprised of eliminating an intake, compression and exhaust strokes.

7. A hybrid heat engine of claim 4 is comprised of compressors, piston internal combustion heat engine, and gas turbine heat engine. The compressors are located in the inlet of a piston internal combustion heat engine and in the outlet of a gas turbine.

8. A hybrid heat engine of claim 4 is comprised of compressors and two gas turbines. The compressors are located in the inlet of a first gas turbine and in the outlet of a second gas turbine.

9. A hybrid heat engine of claim 4 is comprised of compressors and linear free piston engine. The compressors are located in the inlet and outlet of a linear free piston engine.

10. A multistage hybrid compressor system of claim 4 is comprised of a compressors and heat energy exchangers.

11. A compressor of claim 10 is comprised of a piston, a cylinder, two input and two exhaust valves, and two firing spark plugs.

12. A compressor of claim 10 as a converter of heat energy into mechanical energy is comprised of connected compressors in parallel.

13. A compressor of claim 101 as a producer of compressed air is comprised of connecting compressors and air heat energy exchangers serially.

14. A hybrid energy system based on a hybrid thermodynamic cycle of claim 1 is comprised of a hybrid drive system.

15. A hybrid drive system is comprised of a three-stroke cycle internal combustion heat engine, a gas turbine heat engine, a generator, a motor/generator, a battery, a multistage compressor, fuel, carbon dioxide and oxygen containers, air and solar heat energy exchangers, gearbox, and a solar catalytic converter system.

16. An electrical conversion system of claim 4 is comprised of generators connected in series and/or parallel, electrical rectifiers and converters, electrical analog regulators, and an electrical transmission line.

17. An analog regulator is comprised of analog regulator resistors connected in series and/or in parallel to electrical loads and to generators.

18. A thermal module-storage is comprised of a heat energy collector, solar energy concentrators, heat insulation material, electrical resistors, thermal storage material, intermediate rods, and a tracking system.

19. A hybrid thermodynamic cycle of claim 1 is comprised of a method and system of reduction of air-polluting emissions by a process of extracting water from exhaust products, collecting remaining exhaust carbon dioxide with pollutants in a container and then heating remaining exhaust carbon dioxide with pollutants by solar radiation to the temperature of best performance of a catalytic converter.

20. A method of maximum extraction of energy from renewable and fossil fuel sources is comprised the following condition: energy is produced during on or off peak hours should be fully consumed. Eproduced−Econsumed=0

21. A method of maximum extraction of energy from renewable sources of claim 20 is comprised of a step of eliminating the need for aerodynamic, hydraulic, electronic, and mechanical control systems and devices, which are used to reduce stresses created by fluctuations and oscillations of kinetic and mechanical energies.

22. An instantaneous energy produced by a hybrid energy system during on or off peak hours includes electrical and heat energy and compressed air, and is fully consumed and/or collected in the electrical, thermal and air storages, respectively, to satisfy the condition of claim 20.

23. A method of increasing efficiency of hybrid energy system includes management of its system by a computer.

24. A method of increasing efficiency of an offshore hybrid wave-tide-wind energy system is comprised of a step of transmitting electrical energy of connected generators of offshore wave-tide-wind energy power plants in series to electrical grid through an electrical analog regulator resistors and an electrical converter.

25. A hybrid thermodynamic cycle method of claim 1 is comprised of a step of integrating direct and indirect methods of conversion of wind-wave-tide-water kinetic energies into electrical energy.

26. A direct method of conversion of kinetic energies into electrical energies of claim 33 is comprised of coupling wind-wave-tide-water turbines to a coil armature and magnetic field through gearboxes and rotating shafts of this coil armature and magnetic field in a clockwise and in counterclockwise directions.

27. An indirect method of conversion of kinetic energies into electrical energies of claim 25 is comprised of coupling wind-wave-tide-water turbines to a coil armature and magnetic field through compressors and gas turbines and rotating shafts of these gas turbines in a clockwise and in counterclockwise directions.

28. A method of maximum wind energy utilization is comprised of energy extraction from static and dynamic wind.

29. A method of maximum wind energy utilization is comprised of extracting energy from wind by collecting rotational and teetering motions of wind turbines.

30. A method of collecting teetering motions of wind turbines is comprised of converting teetering motion into electricity or the compressed air phase.

31. A method of maximum wind energy utilization of claim 28 is comprised of extracting energy from a wind in front of a tower by static compressors.

32. A hybrid thermodynamic cycle method of claim 1 is comprised of making hybrid mobile solar-tide-wave-natural gas power plants.

33. A method of reduction of stressed created by fluctuations, oscillations and vibrations in the energy conversion system is comprised of dampening down and absorbing all fluctuations, oscillations, and vibrations of kinetic and mechanical energies through the intermediate working substance, such as air.

34. A method of lowering weight of a tower (cost reduction) is comprised of making farms of wind turbines with different lengths and weights of blades.

35. A method of reduction of a working substance temperature is comprised of eliminating oil as lubricant and of constructing compressors with plastic materials.

36. A method of utilizing maximum wave energy by wave turbines of claim 4 is comprised of a mechanical direction switch devices of linear motion into mechanical energy in the phase of rotating compressor shaft in one direction.

37. A method of stabilizing floats is comprised of a step of installing stabilizer systems. Stabilizer systems include water propellers, propulsive systems, motors and support rings.
